(19) United States
(12) Patent Application Publication
(10) Pub. No.: US 2025/0300242 A1
(43) Pub. Date: Sep. 25, 2025

(54) METHOD OF MANUFACTURING MEMBER FOR ELECTROCHEMICAL ELEMENT AND APPARATUS FOR MANUFACTURING ELECTROCHEMICAL ELEMENT

(71) Applicants: Yukihiro IMANAGA, Tokyo (JP); Ryuji HIGASHI, Kanagawa (JP); Soh NOGUCHI, Kanagawa (JP); Shun GOTO, Tokyo (JP); Hiroto SUZUKI, Kanagawa (JP)

(72) Inventors: Yukihiro IMANAGA, Tokyo (JP); Ryuji HIGASHI, Kanagawa (JP); Soh NOGUCHI, Kanagawa (JP); Shun GOTO, Tokyo (JP); Hiroto SUZUKI, Kanagawa (JP)

(21) Appl. No.: 19/082,825

(22) Filed: Mar. 18, 2025

(30) Foreign Application Priority Data
Mar. 18, 2024 (JP) 2024-041929

(51) Int. Cl. H01M 10/42; B05D 3/02; B05D 3/06

(52) U.S. Cl. CPC H01M 10/4235; B05D 3/0254; B05D 3/067; B05D 2202/25; B05D 2401/10; B05D 2502/005; H01M 2220/20

(57) ABSTRACT

A method of manufacturing a member for an electrochemical includes applying a first liquid composition containing a first polymerizable compound and a first solvent to one side of a substrate, polymerizing the first polymerizable compound in the first liquid composition applied to the one side of the substrate, applying a second liquid composition containing a second polymerizable compound and a second solvent to the other side of the substrate, polymerizing the second polymerizable compound in the second liquid composition applied to the rest side of the substrate, and removing the first solvent in the first liquid composition and the second solvent in the second liquid to form structured layers, wherein at least one of region A, to which the first liquid composition is applied, and region B, to which the second liquid composition is applied, overlaps each other by at least 80 percent in a plan view of the substrate.

### CROSS-REFERENCE TO RELATED APPLICATIONS

This patent application is based on and claims priority pursuant to 35 U.S.C. § 119 to Japanese Patent Application No. 2024-041929, filed on Mar. 18, 2024, in the Japan Patent Office, the entire disclosure of which is hereby incorporated by reference herein.

### BACKGROUND

### Technical Field

The present disclosure is related to a method of manufacturing a member for an electrochemical element and an apparatus for manufacturing an electrochemical element.

### Description of the Related Art

All solid state secondary batteries are expected to see increased demand, such as installation in electric vehicles, not only due to their safety features, such as higher resistance to temperature changes and reduced risk of fire compared to typical lithium-ion secondary batteries, but also due to their performance features, such as the ability to support rapid charging. In addition, the demand for thin batteries for applications such as wearable devices and medical patches is increasing, leading to diversification in the requirements for all solid state secondary batteries.

In all solid state batteries formed of a positive electrode, a negative electrode, and a solid electrolyte layer, the laminated body including the positive electrode, the solid electrolyte layer, and the negative electrode is sometimes pressed at extremely high pressure to achieve high density, thereby improving the performance of the all solid state battery. However, damage such as cracks occurring in the solid electrolyte during this pressing process may lead to short circuits between the positive and negative electrodes. To address this issue, technologies to prevent such damage have been proposed.

### SUMMARY

According to embodiments of the present disclosure, a method of manufacturing a member for an electrochemical is provided which includes applying a first liquid composition containing a first polymerizable compound and a first solvent to one side of a substrate, polymerizing the first polymerizable compound in the first liquid composition applied to the one side of the substrate, applying a second liquid composition containing a second polymerizable compound and a second solvent to a rest side of the substrate, polymerizing the second polymerizable compound in the second liquid composition applied to the rest side of the substrate, and removing the first solvent in the first liquid composition after the polymerizing the first polymerizable compound to form a first structured layer and removing the second solvent in the second liquid composition after the polymerizing the second polymerizable compound to form a second structured layer, wherein at least one of region A, to which the first liquid composition is applied, and region B, to which the second liquid composition is applied, overlaps each other by at least 80 percent in a plan view of the substrate.

As another aspect of embodiments of the present disclosure, an apparatus for manufacturing an electrochemical element is provided which includes a device for manufacturing a member for the electrochemical element by the method of manufacturing a member for an electrochemical mentioned above and a device for manufacturing the electrochemical element using the member.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic cross-sectional view of a member for an electrochemical element obtained by executing the method of manufacturing a member for an electrochemical element relating to an embodiment of the present disclosure;

FIG. 2A is a planar schematic view of a member for an electrochemical element from the A side, obtained by executing the method of manufacturing a member for an electrochemical element relating to an embodiment of the present disclosure;

FIG. 2B is a planar schematic view of a member for an electrochemical element from the B side, obtained by executing the method of manufacturing a member for an electrochemical element relating to an embodiment of the present disclosure;

FIG. 2C is a schematic view obtained by merging FIG. 2A and FIG. 2B;

FIG. 3A is a schematic cross-sectional view of a member for an electrochemical element obtained by executing the method of manufacturing a member for an electrochemical element relating to an embodiment of the present disclosure;

FIG. 3B is a top view of a member for an electrochemical element obtained by executing the method of manufacturing a member for an electrochemical element relating to another embodiment of the present disclosure;

FIG. 3C is a top view of a member for an electrochemical element obtained by executing the method of manufacturing a member for an electrochemical element relating to another embodiment of the present disclosure;

FIG. 3D is a top view of a member for an electrochemical element obtained by executing the method of manufacturing a member for an electrochemical element relating to another embodiment of the present disclosure;

FIG. 3E is a top view of a member for an electrochemical element obtained by executing the method of manufacturing a member for an electrochemical element relating to another embodiment of the present disclosure;

FIG. 3F is a top view of a member for an electrochemical element obtained by executing the method of manufacturing a member for an electrochemical element relating to another embodiment of the present disclosure;

FIG. 4A is a schematic diagram illustrating the method of manufacturing a member for an electrochemical element according to an embodiment of the present disclosure;

FIG. 4B is a schematic diagram illustrating the method of manufacturing a member for an electrochemical element according to another embodiment of the present disclosure;

FIG. 5 is a schematic diagram illustrating the device (liquid discharging device) for manufacturing a member for an electrochemical element according to an embodiment of the present disclosure;

FIG. 6 is a schematic diagram illustrating the device (liquid discharging device) for manufacturing a member for an electrochemical element according to another embodiment of the present disclosure;

FIG. 7 is a schematic diagram illustrating a variation of the device for manufacturing a member for an electrochemical element according to an embodiment of the present disclosure;

FIG. 8 is a diagram (part 1) illustrating a configuration of an example of the printing unit employing an inkjet method and transfer method as the liquid composition applying device in a device for manufacturing a member for an electrochemical element according to an embodiment of the present disclosure;

FIG. 9 is a diagram (part 2) illustrating a configuration of an example of the printing unit employing an inkjet method and transfer method as the liquid composition applying device in a device for manufacturing a member for an electrochemical element according to an embodiment of the present disclosure;

FIG. 10 is a schematic cross-sectional view of the electrode relating to an embodiment of the present disclosure;

FIG. 11A is a schematic cross-sectional view of the electrode relating to another embodiment of the present disclosure;

FIG. 11B is a schematic cross-sectional view of the electrode relating to an embodiment of the present disclosure;

FIG. 12 is a schematic cross-sectional view of the electrode relating to another embodiment of the present disclosure;

FIG. 13 is a schematic diagram illustrating an electrochemical element relating to an embodiment pf the present disclosure; and

FIG. 14 is a schematic diagram illustrating a mobile object, which is an electrochemical element relating to an embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a method of manufacturing a member for an electrochemical element is provided which has excellent anti-curl effect or curl inhibition effect.

For example, to prevent damage such as cracks in the solid electrolyte of an all solid state battery, a positive electrode for a solid state battery has been proposed in WO 2020-022111. This positive electrode includes a positive electrode current collector and a positive electrode active material layer-formed on the positive electrode current collector-containing a positive electrode active material, wherein positive electrode guides are arranged along at least two adjacent sides of the outer periphery of the positive electrode active material layer on the surface having the positive electrode active material layer.

In typical methods of manufacturing all solid state batteries, including that disclosed in WO 2020-022111 mentioned above, a positive electrode guide is arranged at the outer periphery of the surface of the positive electrode active material layer that faces the solid electrolyte layer to prevent short circuits between the positive electrode and the negative electrode. The all solid state battery is then manufactured by stacking and pressing these components.

The positive electrode guide is preferably made of a resin, as a certain degree of viscoelasticity is required for it to withstand the pressure applied during pressing. Considering productivity and the shape versatility of the active material layer, such a resin-based positive electrode guide is preferably formed by applying a liquid composition using a coater.

In recent years, the inkjet method has gathered attention as an industrial coater due to its ability to handle small quantities and precise pattern coating while minimizing material loss. Moreover, it allows for precise pattern coating directly from CAD data, obviating the need for plate making (mask). The inkjet method offers high film thickness uniformity, precise droplet placement, and selective coating capabilities.

As the liquid composition enables irregular coating, fine wiring, and the drawing of micro-patterns, photocurable liquid compositions are sometimes used.

In general, photocurable liquid compositions often contains a photoinitiator and an acrylic-based multifunctional monomer. In the case of photocuring using such multifunctional monomers, numerous monomers polymerize into a single molecule, leading to volume shrinkage (hereinafter sometimes referred to as “curing shrinkage”) due to the gap between van der Waals distances and covalent bond distances. This shrinkage can cause issues such as curling or detachment from the substrate.

In the case of forming a resin structured layer as a positive electrode guide (active material layer guide) by applying and curing a photocurable liquid composition, the active material layer becomes thick relative to the electrode substrate (current collector foil), which serves as the substrate, from the perspective of battery energy density. Consequently, the resin structured layer also becomes inevitably thick. As a result, the impact of curing shrinkage in the resin structured layer is significant, leading to noticeable curling of the electrode substrate.

This resultant curl makes handling difficult during the pressing and lamination processes and may cause cracks in the guide during pressing or delamination between the active material layer and the resin structured layer, potentially leading to short circuits.

The method of manufacturing a member for an electrochemical element according to the present disclosure is capable of fully addressing the various issues found in typical techniques. More specifically, if a structured layer is formed on only one side of the substrate, curing shrinkage of the liquid composition causes the substrate to curl; the occurrence of curling, however, can be minimized by forming structured layers on both sides of the substrate. That is, the method of manufacturing a member for an electrochemical element can achieve excellent anti-curl effects.

The present disclosure is described in detail below.

### Method of Manufacturing Member for Electrochemical Element and Apparatus for Manufacturing Member for Electrochemical Element

The method of manufacturing a member for an electrochemical includes applying a first liquid composition containing a first polymerizable compound and a first solvent to one side of a substrate, polymerizing the first polymerizable compound in the first liquid composition applied to the one side of the substrate, applying a second liquid composition containing a second polymerizable compound and a second solvent to the other side (rest side) of the substrate, polymerizing the second polymerizable compound in the second liquid composition applied to the rest side of the substrate, and removing the first solvent in the first liquid composition after the polymerizing the first polymerizable compound to form a first structured layer and removing the second solvent in the second liquid composition after the polymerizing the second polymerizable compound to form a second structured layer, wherein at least one of region A, to which the first liquid composition is applied, and region B, to which the second liquid composition is applied, overlaps each other by at least 80 percent in a plan view of the substrate. Additionally, the method may furthermore optionally include other processes.

The apparatus for manufacturing a member for an electrochemical element relating to the present disclosure includes a device for applying a first liquid composition, a device for polymerizing the first liquid composition, a device for applying a second liquid composition, a device for polymerizing the second liquid composition, and a device for forming a structured layer. Additionally, a storage container and other units may be optionally included.

The method of manufacturing a member for an electrochemical element can be suitably carried out using the apparatus for manufacturing a member for an electrochemical element.

In the present specification, the “first liquid composition” and the “second liquid composition” may be collectively referred to as the “liquid composition” or the “liquid composition for forming a structured layer.”

An embodiment of the member for an electrochemical element obtained by the method of manufacturing the member for an electrochemical element according to the present disclosure will be described with reference to the drawings. The present disclosure is not limited to these embodiments.

In the drawings, identical components may be denoted by the same reference numerals (or symbols), and redundant descriptions may be omitted. Additionally, the present disclosure is not restricted to the specific numbers, positions, or shapes of the configurations described below. These parameters may be appropriately selected to suit the implementation of the present disclosure.

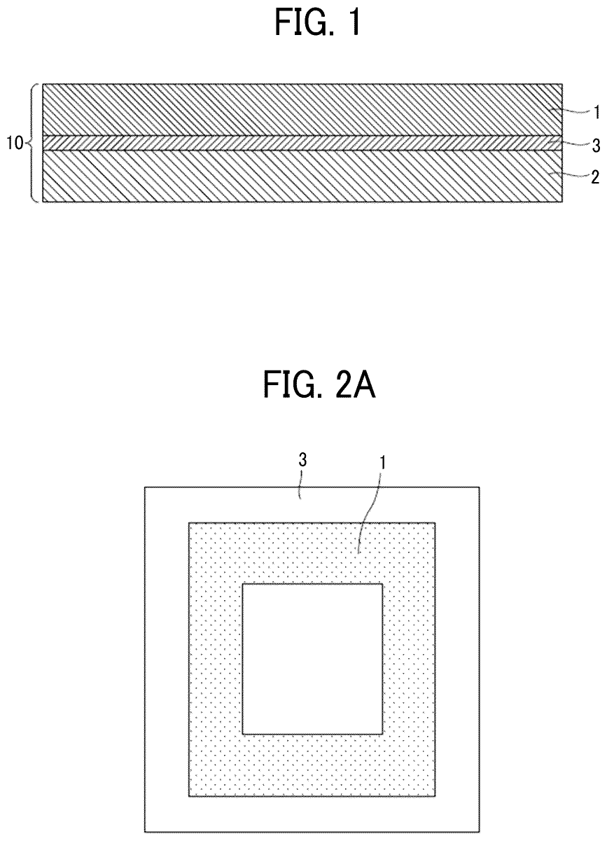

FIG. 1

FIG. 1 is a schematic cross-sectional view of a member for an electrochemical element obtained by executing the method of manufacturing a member for an electrochemical element relating to an embodiment of the present disclosure.

A member 10 for electrochemical elements includes a substrate 3, with a structured layer 1 formed from the first liquid composition and a structure layer 2 formed from the second liquid composition, positioned on opposite sides of the substrate 3.

### Process of Applying First Liquid Composition and Device for Applying First Liquid Composition

The process of applying the first liquid composition is to apply a first liquid composition containing a first polymerizable compound and a first solvent onto one side of a substrate.

The device for applying the first liquid composition is to apply the first liquid composition containing the first polymerizable compound and the first solvent onto one side of a substrate.

The first liquid composition application can be suitably carried out by the device for applying the first liquid composition.

The process of applying the first liquid composition and the device for applying the first liquid composition are not particularly limited and can be suitably selected to suit to a particular application.

Examples include, but are not limited to, spin coating, casting, microgravure coating, gravure coating, bar coating, roll coating, wire bar coating, dip coating, slit coating, capillary coating, spray coating, nozzle coating, gravure printing, screen printing, flexographic printing, offset printing, reverse printing, and inkjet printing. Among these, from the perspective of accurately applying the first liquid composition to a desired location, the inkjet method (technique) is preferred.

### Substrate

The substrate is not particularly limited as long as it has electronic conductivity and is stable with respect to the applied potential. It can be appropriately selected according to a particular application. Examples include, but are not limited to, aluminum foil, copper foil, stainless steel foil, titanium foil, etched foil with fine holes created by etching such foil, carbon-coated foil with a surface layer coated with a carbon-containing resin layer, and perforated substrates used in lithium-ion capacitors.

The shape of the substrate is not particularly limited as long as it is applicable to an electrochemical element and can be appropriately selected according to the intended purpose. A plate-like shape is preferred.

The average thickness of the substrate is not particularly limited and can be appropriately selected according to the intended purpose. It is preferably at most 50 μm from the perspective of improving the volumetric energy density of the electrochemical element and reducing manufacturing costs.

### First Liquid Composition

The first liquid composition contains a first polymerizable compound and a first solvent, and may optionally furthermore contain a surfactant, a polymerization initiator, and other components.

The first liquid composition preferably forms a precursor of a structured layer—the first structured layer—with a porous structure. In other words, through the polymerization and curing of the first polymerizable compound in the first liquid composition, it is preferable to form a precursor of the structured layer with a porous structure having a resin framework (referred to as a “porous structure body,” “resin structure body,” or “porous resin”).

The phrase “the first liquid composition forms a precursor of the structured layer with a porous structure” not only refers to cases where the porous structure is formed within the first liquid composition, but also includes cases where a precursor of the porous structure (e.g., the skeletal part of the porous resin) is formed in the first liquid composition and subsequently undergoes additional treatment (e.g., heat treatment) to form the precursor of the structured layer with a porous structure.

### First Polymerizable Compound

The first polymerizable compound forms a resin upon polymerization and constitutes the skeletal portion of the porous structure due to the composition of the first liquid composition.

As long as the first polymerizable compound forms a polymer (resin) upon polymerization, it is not particularly limited and can be appropriately selected from known polymerizable compounds according to a particular application. From the perspective of polymerization control, it is preferably a compound having at least one radical-polymerizable functional group per molecule and more preferably a compound having two or more radical-polymerizable functional groups.

The first polymerizable compound may include, for example, radical-polymerizable compounds such as monofunctional, bifunctional, or trifunctional (or higher) radical-polymerizable monomers and radical-polymerizable oligomers, as well as functional monomers and functional oligomers that have additional functional groups other than polymerizable functional groups.

Among these, from the perspective of ensuring the mechanical strength of the first polymerizable compound, radical-polymerizable compounds with two or more functional groups are preferred.

The polymerizable group of the first polymerizable compound is not particularly limited and can be appropriately selected according to a particular application. From the perspectives of polymerization rate and conversion rate, at least one of (meth) acryloyl and vinyl groups is preferred, with (meth) acryloyl groups being more preferable.

The first polymerizable compound is preferably polymerizable upon exposure to actinic rays, more preferably polymerizable by heat or light, and even more preferably polymerizable by light.

The resin formed from the first polymerizable compound preferably has a network structure formed upon the application of actinic rays, such as light irradiation or heating. Examples of such resins include, but are not limited to, acrylate resins, methacrylate resins, urethane acrylate resins, vinyl ester resins, unsaturated polyester resins, epoxy resins, oxetane resins, vinyl ether resins, and resins formed via an ene-thiol reaction.

Of these, acrylate resins, methacrylate resins, and urethane acrylate resins, which are formed of a polymerizable compound having a (meth)acryloyl group are more preferable in terms of easiness of forming a structure using radical polymerization with high reactivity and vinyl ester resins, which are formed by a polymerizable compound having a vinyl group are more preferable in terms of productivity.

These can be used alone or in combination. If two or more types are used in combination, the combination of the first polymerizable compounds is not particularly limited and can be suitably selected to suit to a particular application. It is preferable to mix a urethane acrylate resins as the main component with other resins to impart flexibility. The first polymerizable compound having at least one of an acryloyl group and a methacryloyl group is referred to as a polymerizable compound having a (meth)acryloyl group.

The actinic rays or active energy beams are not particularly limited and can be suitably selected as long as they can provide the energy required to advance the polymerization reaction of the first polymerizable compound in the first liquid composition.

Specific examples include, but are not limited to, ultraviolet rays, electron beams, α-rays, β-rays, γ-rays, X-rays, and infrared rays. Of these, ultraviolet is preferable. If a particularly high energy light source is used, polymerization occurs without a polymerization initiator.

The irradiation intensity of the actinic ray is preferably at most 1 W/cm², more preferably at most 300 mW/cm², and even more preferably at most 100 mW/cm². If the irradiation intensity of the actinic rays is too low, excessive phase separation may occur, leading to variations and coarsening of the porous structure. Additionally, the irradiation time becomes longer, reducing productivity. Therefore, an intensity of at least 10 mW/cm² is preferable, and at least 30 mW/cm² is more preferable.

The monofunctional radical polymerizable compound is not particularly limited.

Specific examples include, but are not limited to, 2-(2-ethoxyethoxy) ethyl acrylate, methoxypolyethylene glycol monoacrylate, methoxypolyethylene glycol monomethacrylate, phenoxypolyethylene glycol acrylate, 2-acryloyloxyethyl succinate, 2-ethylhexyl acrylate, 2-hydroxyethyl acrylate, 2-hydroxypropyl acrylate, tetrahydrofurfuryl acrylate, 2-ethylhexyl carbitol acrylate, 3-methoxybutyl acrylate, benzyl acrylate, cyclohexyl acrylate, isoamyl acrylate, isobutyl acrylate, methoxytriethylene glycol acrylate, phenoxytetraethylene glycol acrylate, cetyl acrylate, isostearyl acrylate, stearyl acrylate, and styrene monomers.

These can be used alone or in combination.

The bifunctional radical polymerizable compound is not particularly limited.

Specific examples include, but are not limited to, 1,3-butane diol acrylate, 1,4-butane diol acrylate, 1,4-butane diol dimethacrylate, 1,6-hexane diol diacrylate, 1,6-hexane diol dimethaacrylate, diethylene glycol diacrylate, polyethylene glycol diacrylate, neopentyl glycol diacrylate, bisphenol A-EO-modified diacrylate, bisphenol F-EO-modified diacrylate, neopentyl glycol diacrylate, and tricyclodecane dimethanol diacrylate.

These can be used alone or in combination.

The tri- or higher functional radical polymerizable compound is not particularly limited.

Specific examples include, but are not limited to, trimethylol propane triacrylate (TMPTA), trimethylol propane trimethacrylate, EO-modified trimethylol propane triacrylate, PO-modified trimethylol propane triacrylate, caprolactone-modified trimethylol propane triacrylate, HPA-modified trimethylol propane triacrylate, pentaerythritol triacrylate, pentaerythritol tetra acrylate (PETTA), glycerol triacrylate, ECH-modified glycerol triacrylate, EO-modified glycerol triacrylate, PO-modified glycerol triacrylate, tris(acryloxyrthyl) isocyanulate, dipenta erythritol hexacrylate (DPHA), caprolactone-modified dipenta erythritol hexacrylate, dipenta erythritol hydroxyl dipenta acrylate, alkylized dipenta erythritol tetracrylate, alkylized dipenta erythritol triacrylate, dimethylol propane tetracrylate (DTMPTA), penta erythritol ethoxy tetracrylate, EO-modified phosphoric acid triacrylate, and 2,2,5,5-tetrahydroxy methyl cyclopentanone tetracrylate.

These can be used alone or in combination.

There is no particular limit on the content of the first polymerizable compound, and it can be appropriately selected depending on the purpose. However, it is preferable for the content of the first polymerizable compound to be between 5.0 percent by mass and 70.0 percent by mass, based on the entire amount of the first liquid composition. More preferably, it is between 10.0 percent by mass and 50.0 percent by mass, and even more preferably, between 20.0 percent by mass and 40.0 percent by mass.

If the proportion of the first polymerizable compound is at least 5.0 percent by mass to the entire of the first liquid composition, a three-dimensional network structure of the resin is sufficiently formed to obtain a sufficient porous structure, and the strength of the porous structure obtained is enhanced. This is preferable.

If the proportion of the first polymerizable compound is at most 70.0 percent by mass to the entire of the first liquid composition, the pore size of the porous structure obtained is a few nm or less, which is not too small, the porous structure has an appropriate porosity so that it is possible to inhibit the tendency to make it difficult for liquid or air to permeate the porous structure, which is preferable.

### First Solvent

The first solvent contains a liquid containing a porogen, and may furthermore optionally contain other liquids.

The porogen is liquid compatible with the first polymerizable compound and becomes incompatible (i.e., causing phase separation) with the polymer (resin) in the course of polymerization of the first polymerizable compound in the first liquid composition. If the first liquid composition contains a porogen, the first polymerizable compound forms a porous structure when polymerized. Moreover, it is preferable that the porogen be capable of dissolving a compound (polymerization initiator) that generates radicals or acids upon exposure to light or heat.

These liquids and porogens can be used alone or in combination.

In the present embodiment, the solvent is not polymerizable.

The boiling point of the porogen, whether used alone or in combination with two or more types, is preferably between 50 degrees Celsius and 250 degrees Celsius under atmospheric pressure, more preferably 70 degrees Celsius and 200 degrees Celsius, and even more preferably 120 degrees Celsius and 190 degrees Celsius.

A porogen with a boiling point of at least 50 degrees Celsius is less likely to evaporate near room temperature, making the first liquid composition easier to handle and facilitating the control of its porogen content.

Moreover, if the boiling point of the porogen is at most 250 degrees Celsius, the time taken to remove the porogen after during the formation of the structured layer is shortened and the productivity of the porous resin is improved. In addition, since the proportion of the porogen remaining inside the porous resin can be reduced, the porous resin can be used as a functional layer such as a substance separation layer for separating substances and a reaction layer as a reaction field, which enhances quality.

The porogen is not particularly limited and can be suitably selected to suit to a particular application.

Specific examples include, but are not limited to, ethylene glycols such as diethylene glycol monomethyl ether, ethylene glycol monobutyl ether, ethylene glycol monoisopropyl ether, and dipropylene glycol monomethyl ether, esters such as γ-butyrolactone and propylene carbonate, and an amide such as NN dimethylacetamide.

In addition, other examples include liquids having a relatively large molecular weight such as methyl tetradecanoate, methyl decanoate, methyl myristate, and tetradecane.

Furthermore, liquids such as acetone, 2-ethylhexanol, and 1-bromonaphthalene can also be mentioned.

The liquid specified above is not always a porogen.

Porogens are liquids compatible with the polymerizable compound and becomes incompatible (i.e., causing phase separation) with the polymer (resin) in the course of polymerization of the first polymerizable compound in the first liquid composition. In other words, whether a liquid qualifies as a porogen is determined by its relationship with the first polymerizable compound and the polymer (resin) formed through the polymerization of the first polymerizable compound.

The first liquid composition only needs to contain at least one porogen that has a specific relationship with the first polymerizable compound. As a result, the range of materials available for the preparation of the first liquid composition is expanded, making it easier to design the first liquid composition. By broadening the range of material choices for the preparation of the first liquid composition, the composition can accommodate additional requirements other than forming a porous structure. For example, inkjetting the first liquid composition requires discharge stability. With a wider range of material options, designing the first liquid composition to meet such requirements is facilitated.

There is no particular limitation on the content of the liquid or porogen, and it can be appropriately selected depending on the purpose. However, it is preferable for the content of the porogen to be between 30.0 percent by mass and 95.0 percent by mass, based on the entire amount of the first liquid composition. More preferably, it is between 50.0 percent by mass and 90.0 percent by mass, and even more preferably, between 60.0 percent by mass and 80.0 percent by mass.

If the proportion of the liquid or porogen is at most least 30.0 percent by mass to the entire of the first liquid composition, the pore size of the porous structure obtained is a few nm or less, which is not too small, the porous structure has an appropriate porosity so that it is possible to inhibit the tendency to make it difficult for liquid or air to permeate the porous structure, which is preferable.

If the liquid or porogen content is at most 95.0 percent by mass, a sufficiently three-dimensional network structure of the resin is formed, resulting in a porous structure. Additionally, the strength of the porous structure is improved, which is desirable.

The viscosity of the first solvent in the first liquid composition at 25 degrees Celsius is not particularly limited and may be appropriately selected according to a particular application. However, from the perspective of minimizing film thickness variations and compositional non-uniformity in the coated first liquid composition, a viscosity of 1 mPa's to 150 mPa's is preferred.

The first liquid composition may contain other liquids that are not porogens. The content of such other liquids is not particularly limited and may be appropriately selected according to a particular application. From the perspective of composition control, a content of at most 10.0 percent by mass relative to the entire amount of the first liquid composition is preferred, at most 5.0 percent by mass is more preferred, at most 1.0 percent by mass is even more preferred, and 0 percent by mass (i.e., no inclusion) is particularly preferred.

The mass ratio of the first polymerizable compound in the first liquid composition to the porogen in the first liquid composition (first polymerizable compound: porogen) is not particularly limited and may be appropriately selected according to a particular application. A ratio of 1.0:0.4 to 1.0:19.0 is preferred, a ratio of 1.0:1.0 to 1.0:9.0 is more preferred, and a ratio of 1.0:1.5 to 1.0:4.0 is even more preferred.

### Polymerization-Induced Phase Separation

The porous resin is formed by polymerization-induced phase separation. In the polymerization-induced phase separation, the polymerizable compound and the porogen are compatible, however, the polymer (resin) produced in the process of polymerization of the polymerizable compound and the porogen are incompatible with each other (phase separation occurs). Although there are other methods for obtaining a porous structure by phase separation, a porous medium having a network structure can be formed by using the polymerization-induced phase separation method, so that the porous structure obtained is expected to have highly chemical resistance and heat resistance. Additionally, compared to other methods, it offers the benefits of a shorter process time and easier surface modification.

Next, the process of forming a porous resin using a polymerization-induced phase separation method with the first liquid composition containing the first polymerizable compound will be described. The first polymerizable compound undergoes a polymerization reaction upon exposure to light or other stimuli, forming a resin. During this process, solubility of the growing resin in the porogen decreases. As a consequence, phase separation occurs between the resin and the porogen. Eventually, the resin forms a co-continuous porous structure where the porogen or other materials fill the pores, with the resin forming a skeletal framework. Upon drying, the porogen is removed, leaving behind a porous resin (structured layer) with a three-dimensional networked co-continuous structure. Therefore, in order to form a porous resin having an appropriate porosity, the compatibility between the porogen and the first polymerizable compound and the compatibility between the porogen and the resin formed by polymerizing the porogen and the first polymerizable compound are adjusted.

### First Embodiment

In the first embodiment, the first liquid composition includes a polymerizable compound represented by Chemical Formula 1 and a non-aqueous solvent represented by Chemical Formula 2.

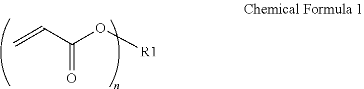

In Chemical Formula 1, R1 represents an n-valent functional group having at least two carbon atoms, which may contain an oxygen atom, and n represents an integer from 2 to 6.

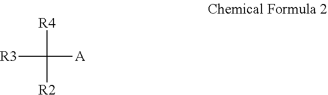

In Chemical Formula 2, R2, R3, and R4 each independently represent hydrocarbon groups, with a total carbon number of at least 4 of R2, R3, and R4, and A represents a hydroxyl group or an amino group represented by —NR₅H, where R5 represents a hydrogen atom, a methyl group, or an ethyl group.

If A in Chemical Formula 2 is a hydroxyl group, the difference in Millikan charge between the hydrogen and oxygen atoms in the hydroxyl group is preferably at least 0.520. If A in Chemical Formula 2 is an amino group, the difference in Millikan charge between the hydrogen and nitrogen atoms in the amino group is preferably at least 0.470.

The first embodiment of the first liquid composition can minimize a decrease in ionic conductivity when a sulfide solid electrolyte layer is used as the solid electrolyte layer in an electrochemical element, while also forming a structured layer with reduced curling.

The polymerizable compound represented by Chemical Formula 1 has no particular limit and can be suitably selected according to a particular application.

Specific examples include, but are not limited to, bifunctional acrylates such as bifunctional alkyl acrylates, hydroxy pivalic acid neopentyl glycol acrylate adducts, bifunctional polyethylene glycol acrylates, bifunctional polypropylene glycol acrylates, bifunctional polytetramethylene glycol acrylates, bifunctional cyclic acrylates, bifunctional alkoxylated aromatic acrylates, and bifunctional acrylic acid polymer ester acrylates, trifunctional acrylate such as trifunctional trimethylol propane acrylate, trifunctional trimethylolpropane acrylates, trifunctional alkoxylated glycerin acrylates, and trifunctional isocyanate acrylates, and tetra-to hexafunctional acryaltes such as tetrafunctional pentaerythritol acrylates, tetrafunctional ditrimethylolpropane acrylates, tetrafunctional diglycerin tetraacrylates, and hexafunctional dipentaerythritol hexaacrylates.

These can be used alone or in combination.

The non-aqueous solvent represented by Chemical Formula 2 is not particularly limited and may be appropriately selected according to a particular application.

Specific examples include, but are not limited to, 2-methyl-2-hexanol, 3,4-dimethyl-1-pentin-3-ol, 3,5-dimethyl-1-hexin-3-ol, 3-ethyl-1-pentin-3-ol, 3-ethyl-3-pentanol, 2-methyl-3-butin-2-ol, tetrahydrolinalool, and 3-methyl-1-phenyl-3-pentanol.

These can be used alone or in combination.

### Second Embodiment

As a second embodiment, the first liquid composition includes a polymerizable compound represented by Chemical Formula 3 and a non-aromatic compound as the first solvent.

The second embodiment of the first liquid composition can simultaneously reduce curing shrinkage and swelling shrinkage during the formation of the structured layer and can also reduce curling even when forming a structured layer with a thickness on the 100 μm scale.

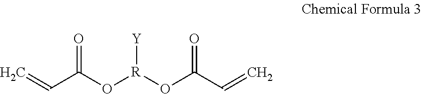

In Chemical Formula 3, R represents at least one of a non-cyclic alkylene group and a non-cyclic alkylene oxide group, and Y represents a hydrogen atom or an —O—COCH═CH₂ group).

The polymerizable compound represented by Chemical Formula 3 has an average molecular weight of less than 700.

The method of measuring the average molecular weight of the first polymerizable compound in the first liquid composition is not particularly limited and may be appropriately selected according to a particular application. One specific example is the gel permeation chromatography (GPC) method.

The Hansen solubility parameters (HSP) of the polymerizable compound represented by Chemical Formula 3 are expressed as (δD^{A}, δP^{A}, δH^{A}), and its volume fraction is represented as X^{A}. The HSP of the solvent is expressed as (δD^{B}, δP^{B}, δH^{B}), and its volume fraction is represented as X^{B}. The HSP of the first liquid composition is expressed as (δD^{C}, δP^{C}, δH^{C}), with the total volume fraction set to X^{A}+X^{B}=1. If the ΔHSP² is given by Equation I and the solubility limit of the first polymerizable compound with the first solvent is represented as ΔHSP²_{SL}, the relationship between ΔHSP² and ΔHSP²_{SL} satisfies Equation II.

$$Δ {HSP}^{2} = {( {δ}_{D}^{A} - {δ}_{D}^{C} )}^{2} + {( {δ}_{P}^{A} - {δ}_{P}^{C} )}^{2} + {( {δ}_{H}^{A} - {δ}_{H}^{C} )}^{2} \qquad Equation I$$

$$0.51 ≦ Δ {HSP}^{2} ≦ Δ {HSP}_{SL}^{2} \qquad Equation II$$

In the case of Y in Chemical Formula 3 being a hydrogen atom, the polymerizable compound is a bifunctional acrylate.

The bifunctional acrylate is not particularly limited and may be appropriately selected according to a particular application. Examples include, but are not limited to, bifunctional non-cyclic alkyl acrylates; bifunctional non-cyclic polyethylene glycol acrylates, bifunctional non-cyclic polypropylene glycol acrylates, and bifunctional non-cyclic polytetramethylene glycol acrylates, which are classified as bifunctional non-cyclic polyalkylene oxide acrylates.

If Y in Chemical Formula 3 is an —O—COCH═CH₂ group (i.e., a group where an oxygen atom is bonded to an acrylic group), the polymerizable compound is a trifunctional acrylate.

The trifunctional acrylate is not particularly limited and may be appropriately selected according to a particular application. Examples include, but are not limited to, trifunctional non-cyclic alkyl acrylates and trifunctional non-cyclic polyalkylene oxide acrylates.

These can be used alone or in combination.

The non-aromatic compound is not particularly limited and may be appropriately selected according to a particular application. Examples include, but are not limited to, alcohol-based solvents, amine-based solvents, hydrocarbon-based solvents, ester-based solvents, ketone-based solvents, aldehyde-based solvents, and thiol-based solvents.

These can be used alone or in combination.

### Third Embodiment

As a third embodiment, the first liquid composition has a light transmittance at a wavelength of 550 nm of at least 30 percent, measured while stirring the first liquid composition, and the rate of increase in the haze value in a haze measurement element produced by polymerizing the first liquid composition is at least 1.0 percent.

### Light Transmittance

The compatibility between the porogen and the first polymerizable compound can be determined by the light transmittance.

In the case of the light transmittance being at least 30 percent, it is determined that the liquid contains a porogen and that the first polymerizable compound and the porogen are in a mutually compatible state. If the light transmittance is less than 30 percent, it is determined that the first polymerizable compound and the liquid are in a non-compatible state.

The method of measuring light transmittance is not particularly limited and can be suitably selected to suit to a particular application. One example of this is presented below.

The first liquid composition is infused into a quartz cell and the light transmittance (visible light) having a wavelength of 550 nm of the first liquid composition was measured while being stirred at 300 rpm using a stirring bar. The measuring conditions are as follows.
Quarz cell: special microcell with a screw cap (trade name: 42016, available from MITORIKA
Transmittance measuring device: USB4000, available from Ocean Optics, Inc
Rate of stirring: 300 rpm
Measuring wavelength: 550 nm
Reference: Light transmittance measured at a wavelength of 550 nm with a quartz cell filled with air (transmittance: 100 percent)

### Increase in Haze Value

The compatibility between the porogen and the resin formed by polymerization of the first polymerizable compound can be determined by the rate of increase in the haze value.

If the rate of increase in the haze value is at least 1.0 percent, it is determined that the liquid contains a porogen and that the resin and the porogen are in a non-compatible state. If the rate of increase in the haze value is less than 1.0 percent, it is determined that the resin and the liquid are in a mutually compatible state.

The haze value in the element for measuring haze increases as the compatibility between the resin formed by polymerization of the first polymerizable compound and the porogen decreases and the haze value decreases as the compatibility increases. Moreover, it shows that as the haze value increases, the resin formed by polymerization of the first polymerizable compound tends to form a porous structure.

There are no particular restrictions on the method of measuring the rate of increase in haze value, and it can be appropriately selected according to a particular application. For example, a method in which the rate of increase in haze value is measured before and after polymerization of a haze measurement element with an average thickness of 100 μm, which is fabricated by polymerizing the first liquid composition, can be used. One example of this is presented below.

### Preparation of Element for Measuring Haze

Resin fine particles as a gap agent are uniformly dispersed on an alkali-free glass substrate by spin coating. Subsequently, the substrate coated with the gap agent and an alkali-free glass substrate to which no gap agent is applied are attached to each other in such a manner that the gap agent is sandwiched between the substrate and the alkali-free glass substrate. Next, the first liquid composition is filled into between the attached substrates utilizing the capillary phenomenon to produce an element for measuring haze before UV irradiation. Subsequently, the element for measuring haze before UV irradiation is irradiated with UV to cause the first liquid composition for measuring haze to cure. Finally, the periphery of the substrate is sealed with a sealant to prepare the element for measuring haze. The size (average particle diameter: 100 μm) of the gap agent corresponds to the average thickness of the element for measuring haze. Various conditions at the time of preparation are as follows.
Alkali-free glass substrate: OA-10G, 40 mm, t=0.7 mm, available from Nippon Electric Glass Co., Ltd.
Gap agent: Resin fine particles Micropearl GS-L100, average particle size 100 μm, available from SEKISUI CHEMICAL CO., LTD.
Spin coating conditions: Amount of liquid dispersion 150 μL, rate of rotation 1000 rpm, time of rotation 30 s
Filled amount of the first liquid composition: 160 μL
UV irradiation conditions: UV-LED is used as a light source, light source wavelength 365 nm, irradiation intensity 30 mW/cm², time of irradiation 20 seconds
Sealant: TB3035B (available from ThreeBond Co., Ltd.)

### Measurement of Haze Value (Cloudiness)

The haze value (cloudiness) is measured using the prepared element for measuring haze before UV irradiation and the element for measuring haze. Using the measurement value for the element for measuring haze before UV irradiation as a reference (haze value 0), the increasing ratio of the measurement value (haze value) for the element for measuring haze to the measurement value (haze value) for the element for measuring haze before UV irradiation is calculated.

Haze Meter NDH 5000 (available from NIPPON DENSHOKU INDUSTRIES Co., Ltd.) can be used as the device for measurement.

### Surfactant

The first liquid composition may contain a surfactant.

The surfactant orients at the gas-liquid interface, reduces foaming and surface tension, and can be used for smoothing and leveling the upper part of the liquid film, that is, so-called leveling of the liquid film.

The surfactant has no specific limit and can be suitably selected to suit to a particular application. Examples are silicone surfactants, acrylic surfactants, and fluorochemical surfactants

These can be used alone or in combination.

These surfactants can be synthesized or procured.

Specific examples of silicone surfactants include, but are not limited to, the following product names: Polyflow series KL-400HF, KL-401, KL-402, KL-406 (all available from KYOEISHA CHEMICAL Co., LTD.); BYK series UV3500, UV3505, UV3510, UV3530, UV3570, UV3575, UV3576 (all available from BYK Chemical Japan Co., Ltd.); Disperlon series UVX-272, NSH-8430HF, 1711EF, LS-001, LS-460, LS-480 (all available from Kusumoto Chemicals Ltd.).

Specific examples of acrylic surfactants include, but are not limited to, the following product names: Polyflow series No. 7, No. 36, No. 50E, No. 56, No. 75, No. 77, No. 85, No. 85HF, No. 90, No. 90D-50, No. 95, No. 99C (all available from KYOEISHA CHEMICAL Co., LTD.); BYK series 3440, 3560 (both available from BYK Chemical Japan Co., Ltd.); Disperlon series 1970, 230, 230HF, LF-1980, LF-1982, LF-1983, LF-1984, LF-1985, UVX-36 (all available from Kusumoto Chemicals Ltd.).

Specific examples of fluorine surfactants include, but are not limited to, the following product names: Surflon series (available from ACG SEIMI CHEMICAL CO., LTD.); Megafac series RS-56, RS-75, RS-72-K, RS-76-E, RS-76-NS, RS-78, RS-90 (all available from DIC Corporation).

Other examples include, but are not limited to, the following product names: BYK-UV3535 (available from BYK Chemical Japan Co., Ltd.); Disperlon series LHP-90, LHP-91, LHP-95, LHP-96 (all available from Kusumoto Chemicals Ltd.).

### Polymerization Initiator

The first liquid composition may contain a polymerization initiator.

The polymerization initiator can produce active species such as a radical or a cation upon application of energy such as light and heat and initiates polymerization of a polymerizable compound.

The polymerization initiator includes, for instance, known radical polymerization initiators, cationic polymerization initiators, and a base generators. Of these, photoradical polymerization initiators are preferable.

These can be used alone or in combination.

There are no particular limitations for photoradical polymerization initiators, and known photoradical initiators can be selected as appropriate according to a particular application.

Specific examples include, but are not limited to, those known by product names such as Irgacure and Darocure, including Mihira ketones and benzophenones, as well as acetophenone derivatives.

Specific compounds include, but are not limited to, α-hydroxy-acetophenone, α-aminoacetophenone, 4-aroyl-1,3-dioxolane, benzyl ketals, 2,2-diethoxyacetophenone, p-dimethylaminoacetophenone, p-dimethylaminopropionophenone, benzophenone, 2-chlorobenzophenone, p,p′-dichlorobenzophenone, p,p′-bisdiethylaminobenzophenone, Mihira ketone, benzyl, benzoin, benzoin dimethyl ketal, tetramethylthiuram monosulfide, thioxanthone, 2-chlorothioxanthone, 2-methylthioxanthone, azobisisobutyronitrile, benzoin peroxide, di-tert-butyl peroxide, 1-hydroxycyclohexylphenyl ketone, 2-hydroxy-2-methyl-1-phenyl-1-one, 1-(4-isopropylphenyl)-2-hydroxy-2-methylpropane-1-one, methylbenzoylformate, benzoin isopropyl ether, benzoin methyl ether, benzoin ethyl ether, benzoin ether, benzoin isobutyl ether, benzoin n-butyl ether, benzoin n-propyl, 1-hydroxycyclohexylphenyl ketone, 2-benzyl-2-dimethylamino-1-(4-morpholinophenyl)-butanone-1, 1-hydroxycyclohexylphenyl ketone, 2,2-dimethoxy-1,2-diphenylethanone-1-one, bis (η5-2,4-cyclopentadien-1-yl)-bis (2,6-difluoro-3-(1H-pyrrole-1-yl)-phenyl) titanium, bis(2,4,6-trimethylbenzoyl)-phenylphosphine oxide, 2-methyl-1 [4-(methylthio)phenyl]-2-morpholinopropane-1-one, 2-hydroxy-2-methyl-1-phenyl-propane-1-one (Darocure 1173), bis(2,6-dimethoxybenzoyl)-2,4,4-trimethyl-pentylphosphine oxide, 1-[4-(2-hydroxyethoxy)-phenyl]-2-hydroxy-2-methyl-1-propane-1-one-monoacylphosphine oxide, bisacylphosphine oxide; titanocene, fluorenone, anthraquinone, thioxanthone, xanthone, Roffindimer, trihalogenated compounds, and dihalomethyl compounds, active ester compounds, organic boron compounds.

Furthermore, a photocrosslinking radical producing agent such as a bisazide compound may be contained at the same time.

If only heat is used for polymerization, a thermal polymerization initiator such as azobisisobutyronitrile (AIBN) which is a normal radical producing agent can be used.

The proportion of the first polymerization initiator is not particularly limited and can be suitably selected to suit to a particular application. The content is preferably 0.05 to 10.0 percent by mass, and more preferably 0.5 to 5.0 percent by mass, of the entire polymerizable compound to achieve a sufficient curing rate.

The first liquid composition may contain either a dispersion composition containing a dispersion or in the first liquid composition or a non-dispersion composition containing no dispersion, which is preferable.

### Viscosity

The viscosity of the first liquid composition is preferably at least 5 mPa's from the perspective of stabilizing the average thickness of the structured layer formed by curing the first liquid composition. From the perspective of inkjet discharging, a viscosity between 8 mPa's and 20 mPa's is more preferable.

The viscosity refers to the value measured at a rotational speed of 100 rpm at 25 degrees Celsius, and specifically, the viscosity measured using a TV25-type viscometer (cone-plate) at a rotational speed of 100 rpm is adopted.

### Hansen Solubility Parameters (HSP)

The compatibility of the porogen with the first polymerizable compound, as well as the compatibility between the porogen and the resin formed by polymerizing the first polymerizable compound, can be predicted through Hansen Solubility Parameters (HSP).

The Hansen Solubility Parameter (HSP) is a useful tool for predicting the compatibility of two substances, a parameter discovered by Charles M. Hansen. Hansen Solubility Parameter (HSP) is represented by combining the following experimentally and theoretically derived three parameters (δD, δP, and δH). Hansen solubility parameter (HSP) is represented in MPa^{0.5} or (J/cm³)^{0.5}. In the present embodiment, (J/cm³)^{0.5} is employed.
δD: Energy derived from London dispersion force.
δP: Energy derived from dipole-dipole interactions
δH: Energy derived from hydrogen bonding force

The Hansen solubility parameter (HSP) is a vector quantity represented as (δD, δP, δH), and represented by plotting on a three-dimensional space (Hansen space) having these three parameters as coordinate axes. For the Hansen solubility parameters (HSP) of commonly used substances, there is a known information source such as a database. Therefore, for example, the Hansen solubility parameter (HSP) of a substance is obtained by referring to the database. Regarding a substance whose Hansen Solubility Parameters (HSP) is not registered in the database, it can be calculated from the chemical structure of the substance and Hansen Solubility Sphere Method using computer software such as Hansen Solubility Parameters in Practice (HSPiP). The Hansen solubility parameter (HSP) of a mixture containing two or more substances is calculated as a vector sum of values obtained by multiplying the Hansen solubility parameter (HSP) of each substance by the volume ratio of each substance to the entire mixture. In the present embodiment, the Hansen solubility parameter (HSP) of the liquid (porogen) obtained based on a known information source such as a database is referred to as “Hansen solubility parameter of liquid”.

Also, relative energy difference (RED) based on the Hansen solubility parameter (HSP) of a solute and the Hansen solubility parameter (HSP) of a solution is represented by the following Relationship 1.

$$Relative energy difference ( RED ) = Ra / Ro \qquad Relationship 1$$

In Relationship 1, Ra represents the HSP distance between the Hansen solubility parameter (HSP) of a solute and the Hansen solubility parameter (HSP) of a solution, and Ro represents the interaction radius of the solute. The HSP distance (Ra) between the Hansen Solubility Parameters (HSP) indicates the distance between the two substances. A smaller value means that two types of substances are closer to each other in the three-dimensional space (Hansen space) and indicates that the possibility of mutual dissolution (compatibility) increases.

Assuming the Hansen Solubility Parameters (HSP) for the two substances (solute A and solution B) are as follows, Ra can be calculated as follows.

$${HSP}^{A} = ( δ {D}^{A} , δ {P}^{A} , δ {H}^{A} )$$

$${HSP}^{B} = ( δ {D}^{B} , δ {P}^{B} , δ {H}^{B} )$$

$$Ra = {[ 4 \times {( δ {D}^{A} - δ {D}^{B} )}^{2} + {( δ {P}^{A} - δ {P}^{B} )}^{2} + {( δ {H}^{A} - δ {H}^{B} )}^{2} ]}^{1 / 2}$$

Ro (interaction radius of solute) can be determined by, for example, the Hansen solubility sphere method described below.

### Hansen Dissolution Sphere Method

First, a substance whose Ro is required and several dozens of liquids for evaluation having known Hansen solubility parameters (HSP) (liquids which are different from the above-mentioned “liquid (porogen)”) are prepared and subjected to a compatibility test of the substance to each of the liquids for evaluation. In the compatibility test, the Hansen solubility parameter (HSP) of the liquids for evaluation demonstrating compatibility and the Hansen solubility parameter (HSP) of the liquids for evaluation not demonstrating compatibility are plotted in the Hansen space. Based on the Hansen solubility parameter (HSP) of each of the plotted liquids for evaluation, a virtual sphere (Hansen sphere) is created including the Hansen solubility parameters (HSP) of the liquid group for evaluation demonstrating compatibility while excluding the Hansen solubility parameters of the liquid group for evaluation not demonstrating compatibility. The radius of the Hansen sphere is the interaction radius Ro of the substance and the center is the Hansen solubility parameter (HSP) of the substance. Note that the evaluator sets the evaluation criteria for compatibility (i.e., the criteria for determining whether the substance is compatible) between the substance for which the interaction radius Ro and Hansen solubility parameters (HSP) are to be determined and one or more evaluation liquids with known Hansen solubility parameters (HSP).

### Hansen Solubility Parameter (HSP) and Interaction Radius of First Polymerizable Compound

Hansen solubility parameter (HSP) of the first polymerizable compound in this embodiment and the interaction radius of the first polymerizable compound are determined by the Hansen solubility sphere method. The evaluation criteria for compatibility in the Hansen dissolution sphere method are set by the evaluator themselves. Therefore, the Hansen solubility parameter (HSP) of the first polymerizable compound in the present embodiment obtained by the following criteria is referred to as Hansen solubility parameter C of the first polymerizable compound and the interaction radius of the first polymerizable compound is represented as interaction radius D of the first polymerizable compound. In other words, unlike the Hansen solubility parameter (HSP) of the first solvent obtained based on a known data sources such as database, the Hansen solubility parameter C of the first polymerizable compound and the interaction radius D of the first polymerizable compound are obtained based on the Hansen dissolution sphere method including the evaluation criteria of compatibility set by the evaluator himself.

According to the following measuring methods [1-1] and Light Transmittance, the Hansen solubility parameter C and the interaction radius D of the first polymerizable compound are obtained based on the evaluation of compatibility between the first polymerizable compound and one or more liquids for evaluation, which is based on light transmittance of a composition for measuring transmittance measured at a wavelength of 550 nm while stirring the composition for measuring transmittance containing the first polymerizable compound and the one or more liquids for evaluation.

### [1-1] Preparation of Composition for Measuring Light Transmittance

First, the first polymerizable compound whose Hansen solubility parameter (HSP) is desired and several dozen types of liquids for evaluation with known Hansen solubility parameters (HSP) are prepared and the first polymerizable compound, each liquid for evaluation, and a polymerization initiator are mixed with the following ratio to prepare a composition for measuring light transmittance. Dozens of liquids for evaluation with known Hansen solubility parameters (HSP) are 21 types of liquids for evaluation below. Proportion of Composition for Measuring Light Transmittance
First polymerizable compound whose Hansen solubility parameter (HSP) is desired: 28.0 percent by mass
Liquid for evaluation with known Hansen solubility parameter (HSP): 70.0 percent by mass
Polymerization initiator (Irgacure 819, available from BASF SE): 2.0 percent by mass Liquid Group (21 types) for Evaluation

Ethanol, 2-propanol, mesitylene, dipropylene glycol monomethyl ether, N-methyl 2-pyrrolidone, γ-butyrolactone, propylene glycol monomethyl ether, propylene carbonate, ethyl acetate, tetrahydrofuran, acetone, n-tetradecane, ethylene glycol, diethylene glycol monobutyl ether, diethylene glycol butyl ether acetate, methyl ethyl ketone, methyl isobutyl ketone, 2-ethylhexanol, diisobutyl ketone, benzyl alcohol, and 1-bromonaphthalene

### Hansen Solubility Parameter (HSP) and Interaction Radius of Resin Formed by Polymerization of First Polymerizable Compound

Hansen solubility parameter (HSP) of the resin formed by the polymerization of the first polymerizable compound and the interaction radius of the resin formed by the polymerization of the first polymerizable compound are determined by the Hansen solubility sphere method. The criteria for evaluating compatibility in the Hansen solubility sphere method are set by the evaluator themselves and are determined based on the following criteria. The Hansen Solubility Parameter (HSP) of the resin formed by the polymerization of the first polymerizable compound in the present embodiment is referred to as the “resin's

Hansen Solubility Parameter A,” and the interaction radius of the resin formed by the polymerization of the first polymerizable compound is referred to as the “resin's interaction radius B.” In other words, unlike the Hansen solubility parameter (HSP) of the liquid obtained based on a known data sources such as database, the Hansen solubility parameter A of the resin and the interaction radius B of the resin are obtained based on the Hansen solubility sphere method including the evaluation criteria of compatibility set by the evaluator themselves.

The Hansen solubility parameter A and the interaction radius B of a resin are obtained by evaluating the compatibility of the resin with a solvent for evaluation according to the following [2-1] and Increase in Haze Value, based on the increasing ratio of haze (cloudiness) value in an element for measuring haze prepared using a first polymerizable compound and a composition for measuring haze containing a solvent for evaluation.

### [2-1] Preparation of Composition for Measuring Haze

First, the precursor (the first polymerizable compound) of a resin whose Hansen solubility parameter (HSP) is desired and several dozen types of liquids for evaluation with known Hansen solubility parameters (HSP) are prepared and the first polymerizable compound, each liquid for evaluation, and a polymerization initiator are mixed with the following ratio to prepare a composition for measuring haze. Dozens of liquids for evaluation with known Hansen solubility parameters (HSP) are 21 types of liquids for evaluation below.

### Proportion of Composition for Measuring Haze

Precursor (first polymerizable compound) of resin whose Hansen solubility parameter (HSP) is desired: 28.0 percent by mass
Liquid for evaluation with known Hansen solubility parameter (HSP): 70.0 percent by mass
Polymerization initiator (Irgacure 819, available from BASF SE): 2.0 percent by mass Liquid Group (21 types) for Evaluation

Ethanol, 2-propanol, mesitylene, dipropylene glycol monomethyl ether, N-methyl 2-pyrrolidone, γ-butyrolactone, propylene glycol monomethyl ether, propylene carbonate, ethyl acetate, tetrahydrofuran, acetone, n-tetradecane, ethylene glycol, diethylene glycol monobutyl ether, diethylene glycol butyl ether acetate, methyl ethyl ketone, methyl isobutyl ketone, 2-ethylhexanol, diisobutyl ketone, benzyl alcohol, and 1-bromonaphthalene

### Relative Energy Difference (RED) Based on Hansen Solubility Parameter (HSP) of Resin and Liquid (Porogen)

The relative energy difference (RED) calculated according to the following relationship of the Hansen solubility parameter A of the resin formed by the polymerization of the first polymerizable compound determined based on the increase ratio of the haze value (cloudiness) of the element for measuring haze prepared using the composition for measuring haze containing the first polymerizable compound and the liquid for evaluation, the interaction radius B of the resin, and the Hansen solubility parameter of the porogen is preferably at least 1.00, more preferably at least 1.10, and furthermore preferably at least 1.20, and particularly preferably at least 1.30.

Relative energy difference (RED)=Distance between Hansen solubility parameter A of resin and Hansen solubility parameter of liquid/Interaction radius B of resin

If the relative energy difference (RED) based on the Hansen solubility parameter (HSP) of the resin and the porogen is at least 1.00, the resin formed by polymerization of the first polymerizable compound in the first liquid composition and the porogen are likely to cause phase separation and a porous resin is easily formed, which is preferable.

### Relative Energy Difference (RED) Based on Hansen Solubility Parameter (HSP) of First Polymerizable Compound and Liquid (Porogen)

The relative energy difference (RED) calculated based on the following relationship based on the Hansen solubility parameter C of the first polymerizable compound, determined based on the light transmittance at a wavelength of 550 nm of the composition for measuring transmittance measured during stirring of the composition for measuring transmittance containing the first polymerizable compound and the liquid for evaluation, the interaction radius D of the first polymerizable compound determined based on the compatibility of the first polymerizable compound and the liquid for evaluation, and the Hansen solubility parameter of the liquid, is preferably at most 1.05, more preferably at most 0.90 furthermore preferably at most 0.80, and particularly preferably at most 0.70.

Relative energy difference (RED)=Distance between Hansen solubility parameter C of first polymerizable compound and Hansen solubility parameter of liquid/Interaction radius D of first polymerizable compound

If the relative energy difference (RED) based on the Hunsen solubility parameter (HSP) of the first polymerizable compound and the porogen is at most 1.05, the first polymerizable compound and the porogen tend to be compatible. As the relative energy difference (RED) approaches zero, both become more compatible. For this reason, if the relative energy difference (RD) is at most 1.05, a liquid composition is obtained which demonstrates a high level of solution stability in which the first polymerizable compound does not precipitate over time after the first polymerizable compound is dissolved in the porogen. Since the first polymerizable compound has a high level of solubility in the porogen, discharging stability of the liquid composition can be maintained. For example, the first liquid composition of the present embodiment can be applied to the method of discharging the first liquid composition such as the inkjet printing method. Also, when the relative energy difference (RED) is at most 1.05, separation between the first polymerizable compound and the porogen in the state of the first liquid composition before the polymerization reaction starts is reduced so that irregular or nonuniform porous resin is not easily formed.

### Method of Manufacturing First Liquid Composition

There are no particular limitations on the method of manufacturing the first liquid composition, and it can be appropriately selected according to a particular application. The first liquid composition is preferably manufactured through processes such as dissolving a polymerization initiator in the first liquid composition and dissolving porogen and other component therein, followed by stirring to prepare a uniform solution.

### Process of Polymerizing First Liquid Composition and Device for Polymerizing First Liquid Composition

In the process of polymerizing the first liquid composition, the first polymerizable compound contained in the first liquid composition applied undergoes polymerization.

The device for polymerizing the first liquid composition polymerizes the first polymerizable compound contained in the first liquid composition applied.

The process of polymerizing the first liquid composition can be suitably carried out by the device for polymerizing the first liquid composition.

Through the process of polymerizing the first liquid composition, the first polymerizable compound in the first liquid composition undergoes polymerization, and precursors of the structured layer are formed due to polymerization-induced phase separation.

As the process of polymerizing the first liquid composition and the device for polymerizing the first liquid composition, there is no particular limitation as long as it can provide the energy required to advance the polymerization reaction of the first polymerizable compound. It can be appropriately selected according to a particular application, and examples include irradiation of light such as ultraviolet rays, electron beams, a-rays, β-rays, y-rays, X-rays, and infrared rays, as well as irradiation of electron beams and heating. Among these, it is preferable from the perspective of curl suppression that the polymerization can be carried out at a temperature at or below the boiling point of the solvent contained in the first liquid composition. As a method of polymerization at or below the boiling point of the solvent contained in the first liquid composition, light irradiation is preferred, with ultraviolet irradiation being more preferable.

Note that in the case of using a particularly high-energy light source, polymerization reactions can be facilitated even without the use of a polymerization initiator.

There are no particular limitations on the irradiation intensity of the actinic energy rays, and it can be appropriately selected according to a particular application. An intensity of at most 1 W/cm² is preferable, at most 300 mW/cm² is more preferable, and at most 100 mW/cm² is even more preferable. If the irradiation intensity of the actinic energy rays is too low, excessive phase separation may occur, leading to variations and coarsening of the structured layer. Additionally, the irradiation time becomes longer, reducing productivity. Therefore, an intensity of at least 10 mW/cm² is preferable, and at least 30 mW/cm² is more preferable.

### Process of Applying Second Liquid Composition and Device for Applying Second Liquid Composition

In the process of applying a second liquid composition, the second liquid composition containing a second polymerizable the other side of a substrate.

The device for applying the second liquid composition applies the second liquid composition containing the second polymerizable compound and the second solvent onto the other side of the substrate.

The second liquid composition application can be suitably carried out by the device for applying the second liquid composition.

The device for applying the second liquid composition and the substrate can adopt those described in Process of Applying First Liquid Composition and Device for Applying First Liquid Composition, and therefore, redundant descriptions are omitted.

In the method of manufacturing a member for an electrochemical element relating to the present disclosure, curling can be suppressed by applying the liquid composition to both sides of a substrate, thereby canceling the stress caused by the curing shrinkage of the liquid composition from both sides of the substrate.

Therefore, from the perspective of balancing the stress on both sides of the substrate, it is preferable that the process of applying the second liquid composition apply the second liquid composition in the same pattern as the process of applying the first liquid composition.

In other words, the first liquid composition and the second liquid composition are preferably applied to the front and back surfaces of the substrate in the same pattern.

Furthermore, if the first and second liquid compositions are applied in the same pattern, it is preferable that each pattern be applied to the same portion through the front and back surfaces of the substrate.

### Second Liquid Composition

The second liquid composition contains the second polymerizable compound and the second solvent, and may optionally furthermore contain a surfactant, a polymerization initiator, and other components.

The second liquid composition can be the same as the first liquid composition described in First Liquid Composition, so the redundant description is omitted.

The second liquid composition may have the same composition as the first liquid composition or may have a different composition. However, from the perspective of curl suppression, it is preferable to use the same composition as the first liquid composition.

If the compositions of the first and second liquid compositions differ, the difference between the boiling point of the first solvent and the boiling point of the second solvent is preferably at most 10 degrees Celsius.

If the difference between the boiling points of the first and second solvents is at most 10 degrees Celsius, the volatility of the solvents in each liquid composition during the structured layer formation can be aligned, leading to a better curl suppression effect.

### Process of Polymerizing Second Liquid Composition and Device for Polymerizing Second Liquid Composition

In the process of polymerizing the second liquid composition, the second polymerizable compound contained in the second liquid composition applied undergoes polymerization.

The device for polymerizing the second liquid composition polymerizes the second polymerizable compound contained in the second liquid composition applied.

The second liquid composition polymerization can be suitably carried out by the device for polymerizing the second liquid composition.

The second liquid composition, through the second liquid composition polymerization, undergoes polymerization of the second polymerizable compound in the second liquid composition, and as a result, the precursor of the structured layer is formed by polymerization-induced phase separation.

Since the device for polymerizing the second liquid composition is the same as the content described in Process of Polymerizing First Liquid composition and Device for Polymerizng First Liquid Composition, the redundant description is omitted.

### Process of Forming Structured Layer and Device for Forming Structured Layer

In the process of forming the structured layer, the solvent in the first liquid composition after the first liquid composition polymerization and the solvent in the second liquid composition after the second liquid composition polymerization are removed, thereby forming the structured layer.

The device for forming the structured layer removes the solvent in the first liquid composition after the first liquid composition polymerization and in the second liquid composition after the second liquid composition polymerization are removed, thereby forming the structured layer.

The structured layer formation can be suitably carried out using the structured layer forming device.

In the process of forming the structured layer, both the first solvent and the second solvent are preferably removed simultaneously.

As the process of and the device for forming the structured layer, there are no particular restrictions as long as the solvent in the liquid composition can be removed, and it can be appropriately selected according to a particular application. For example, heating devices can be used.

As the heating device, there are no particular restrictions, and it can be appropriately selected according to the purpose. It includes, for instance, a resistance heating device, an infrared heater, and a fan heater.

Although the heating device has not particular restriction, from the perspective of easily achieving curl suppression effects, it is preferable to remove the solvent by applying warm air from both sides of the substrate.

A stage can be used for heating or heating device other than the stage can be also used. The heating mechanism may be installed on either side of the substrate or may be installed in multiple places.

The heating temperature is not particularly limited and can be selected as appropriate. From the perspective of energy efficiency, a range of 70 to 150 degrees Celsius is preferable.

### Structured Layer

In the present disclosure, the structured layer is such that at least one of the region A, where the first liquid composition is applied, and the region B, where the second liquid composition is applied, overlaps with the other by at least 80 percent a plan view. Furthermore, it is preferable that both the region A, where the first liquid composition is applied, and the region B, where the second liquid composition is applied, overlap with each other by at least 80 percent in a plan view.

In the present specification, the ratio between the region A, where the first liquid composition is applied, and the region B, where the second liquid composition is applied, in a plan view may be referred to as the “overlap ratio.” In addition, the surface on which the region A is provided is referred to as the “surface A” and the surface on which the region B is provided is referred to as the “surface B.” Furthermore, the overlap ratio as viewed from the surface A is referred to as the “overlap ratio A,” and the overlap ratio as viewed from the surface B is referred to as the “overlap ratio B.”

That is, in the present disclosure, the structured layer has an overlap ratio A or overlap ratio B of at least 80 percent, and it is more preferable that both the overlap ratio A and the overlap ratio B are at least 80 percent.

If each overlap ratio of the structured layer is at least 80 percent, a better curl suppression effect can be achieved.

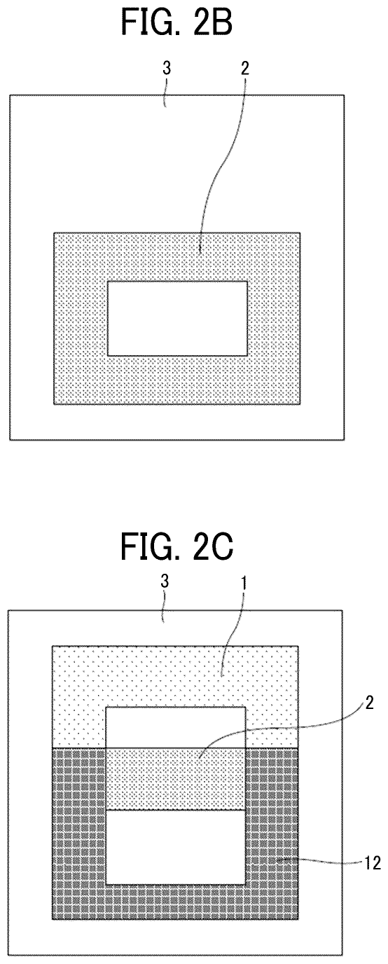

There are no particular restrictions on the method of measuring the overlap ratio in the structured layer, and it can be appropriately selected according to a particular application. One example is described with reference to FIGS. 2A to 2C.

FIGS. 2A to 2C

FIG. 2A is a planar schematic view of a member for an electrochemical element from the A side, obtained by executing the method of manufacturing a member for an electrochemical element relating to an embodiment of the present disclosure. FIG. 2B is a planar schematic view of a member for an electrochemical element from the B side, obtained by executing the method of manufacturing a member for an electrochemical element relating to an embodiment of the present disclosure. FIG. 2C is a schematic view of FIGS. 2A and 2B merged together.

### Method of Measuring Overlap Ratio

For the member for an electrochemical element, images of the surface A and surface B, where the structured layers are formed, are captured using an optical microscope (VHX-7000, available from KEYENCE CORPORATION) to create image data (refer to FIGS. 2A and 2B). The shooting conditions are a lens magnification of 20× and divided shooting (2D stitching). The area of region A on the surface A and the area of region B on the surface B are calculated using the area measurement function of the luminance extraction area installed on the VHX-7000. Next, using the image data from the surface A and surface B, a merged image is created using the image processing software ImageJ, and the overlapping area 12 between the region A and region B is calculated. The overlap ratio A and overlap ratio B are calculated using the following formulas:

$$Overlap ratio A = ( overlap area / area of region A ) \times 100$$

$$Overlap ratio B = ( overlap area / area of region B ) \times 100$$

It is preferable for the structured layer to have a porous structure, and more preferably to have a co-continuous structure with resin as its framework.

The term “co-continuous structure” refers to a structure in which two or more materials or phases each have a continuous structure and do not form an interface. In the present embodiment, it refers to a structure where both the polymetization phase and the void phase are three-dimensional, branched, networked continuous phases. Such a structure can be formed, for example, by polymerizing a liquid composition using a polymerization-induced phase separation method.

To confirm that the structured layer has a co-continuous structure with continuous pores, for example, scanning electron microscopy (SEM) can be used to observe the cross-section of the structured layer and verify the continuity of the connections between the pores. One of the properties inherent to such continuous pores is air permeability.

### Image Observation Using Scanning Electron Microscopy (SEM) and Measurements of Porosity

There are no particular restrictions on the porosity of the structured layer, and it can be appropriately selected according to a particular application. A porosity of at least 30 percent is preferred, and at least 50 percent is even more preferable. Additionally, a porosity of at most 90 percent is preferred, and at most 85 percent is even more preferable.

A porosity of the structured layer of at least 30 percent alleviates the pressure on the solid electrolyte layer from the structured layer during the pressing process after the solid electrolyte layer is formed. A porosity of the structured layer of at most 90 percent ensures adequate shape retention of the structured layer after the pressing process.

There are no particular restrictions on the method of evaluating the porosity of the structured layer, and it can be appropriately selected according to a particular application. One way of evaluating the porosity of the structured layer includes performing osmium staining on the structured layer, followed by vacuum impregnation with epoxy resin, cutting the internal cross-section structure using a focused ion beam (FIB), and measuring the porosity using a scanning electron microscope (SEM).

### Air Permeability

The air permeability of the structured layer is not particularly limited and can be appropriately selected according to the purpose. Preferably, it is not more than 1,000 seconds/100 mL, more preferably not more than 500 seconds/100 mL, and even more preferably not more than 300 seconds/100 mL.

The air permeability of the structured layer is measured in accordance with JIS P8117 (Paper and board-Determination of air permeance and air resistance (medium range)-Gurley method) and can be measured using, for example, a Gurley densometer (available from Toyo Seiki Seisaku-Sho, Ltd.).

As one example, it may be determined that the pores are interconnected or continuous if the air permeability is not more than 1,000 seconds/100 mL.

The pore's cross-section shape in the structured layer is not particularly limited and can be appropriately selected according to a particular application. Examples include, but are not limited to, substantially circular, elliptical, or polygonal shapes.

There are no particular restrictions on the size of the pore, and it can be appropriately selected according to a particular application. However, from the perspective of ease of liquid or gas infiltration and ensuring the strength of the porous structure, it is preferable that the pore size be between 0.01 μm and 10 μm.

The size of the pore refers to the length of the longest portion in the cross-section. The size of the pore can be determined from a cross-section photograph taken by a scanning electron microscope (SEM).

The size of the pores in the structured layer is not particularly limited and can be appropriately selected according to the purpose. Preferably, the ratio of the pore size to the median diameter of the solid electrolyte contained in the liquid composition for forming the solid electrolyte layer (liquid composition for solid electrolyte layer) applied on the structured layer is less than 1, and more preferably 0.8 or less.

If the pore size in the structured layer is larger than the median diameter of the solid electrolyte, the solid electrolyte is more likely to become trapped within the pores of the structured layer. Having a ratio smaller than 1 makes it possible to configure the structure so that the solid electrolyte is less likely to be included in the structured layer, which is advantageous in terms of pressure distribution during pressing and relieving the pressure exerted on the solid electrolyte from the structured layer.

There are no particular limitations on the methods of controlling the pore size and porosity of the structured layer, and they can be appropriately selected according to the purpose. Examples include, but are not limited to, adjusting the content of the polymerizable compound in the liquid composition, adjusting the content of the solvent in the liquid composition, and adjusting the irradiation conditions of the actinic ray.

There is no particular restriction on the average thickness of the structured layer, and it can be appropriately selected according to a particular application and various conditions, such as the average thickness of the electrode composite layer. The average thickness of the structured layer is preferably from 1.0 to 150.0 μm and more preferably from 10.0 to 100.0 μm.

An average thickness of the structured layer of at least 10.0 μm can suitably distribute the pressure load during pressing and prevent short circuits between the positive and negative electrodes.

If the average thickness of the structured layer is at most 100.0 μm, it is possible to manufacture an electrochemical element with high density and excellent battery characteristics.

The average thickness of the structured layer can be determined by measuring the thickness at three or more arbitrary points and calculating the average.

If the average thickness of the structured layer formed from the first liquid composition is denoted as average thickness C (μm), and the average thickness of the structured layer formed from the second liquid composition is denoted as average thickness D (μm), each average thickness is preferably such that it satisfies the following Relationships 1 and 2 from the perspective of superior curl suppression effect.

$$\vert C - D \vert \leq C \qquad Relationship 1$$

$$\vert C - D \vert \leq D \qquad Relationship 2$$

The structured layer may be continuously provided on the substrate, discontinuously provided, or a combination thereof.

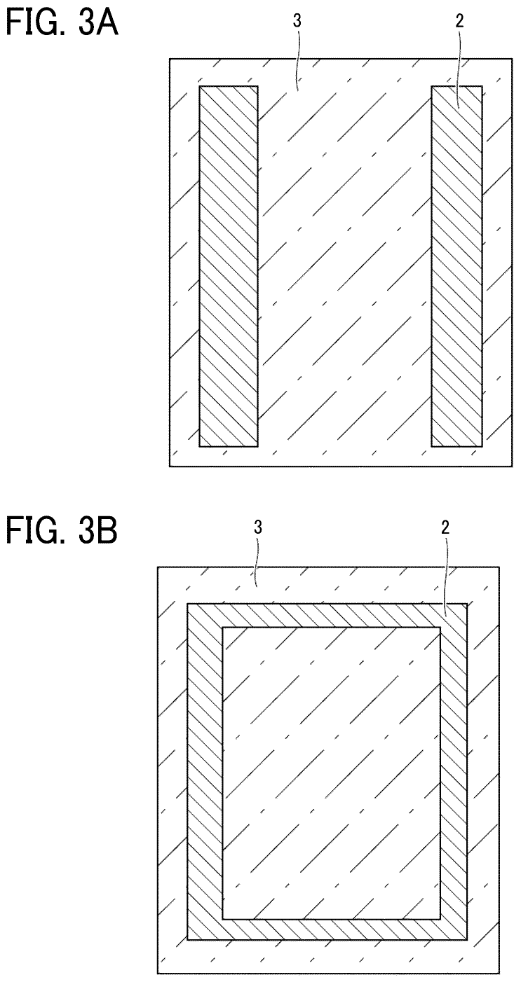

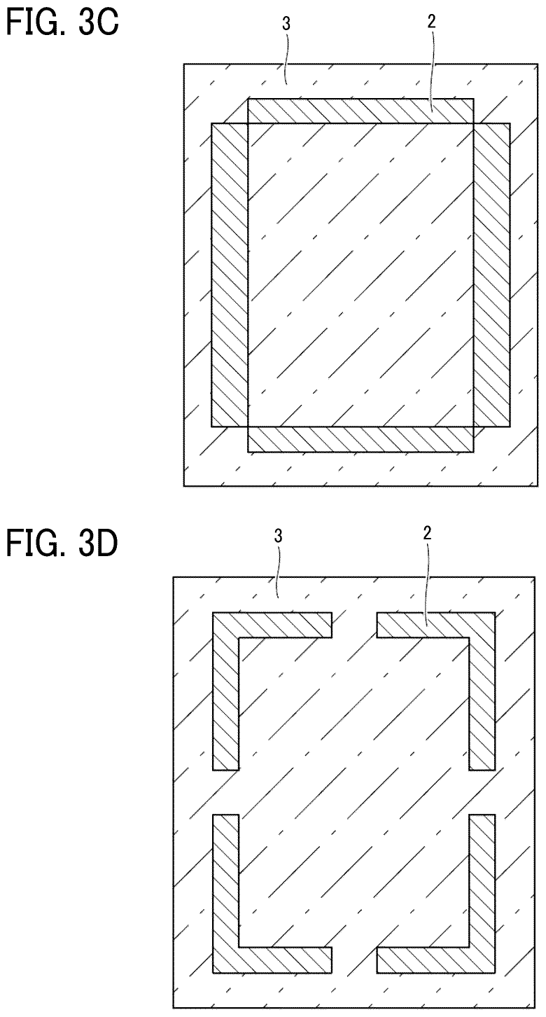

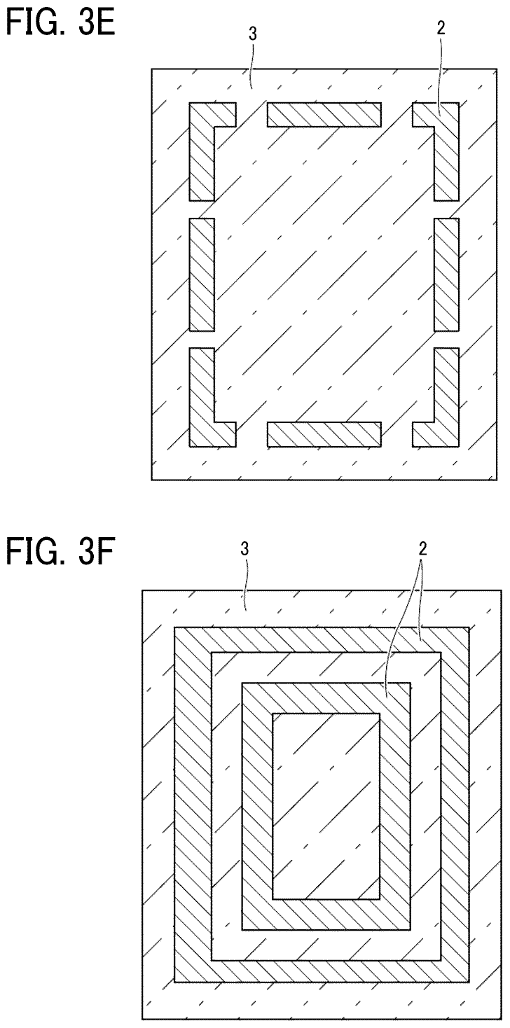

The shape and placement area of the structured layer will be explained with reference to the drawings. FIGS. 3A to 3F are top views of members for electrochemical elements obtained by the method of manufacturing a member for an electrochemical element according to one embodiment of the present disclosure, as well as top views of other embodiments.

FIGS. 3A to 3F

FIGS. 3A to 3F each illustrate structured layers 2 that are continuously or discontinuously provided on a substrate 3.

There are no particular limitations on the shape of the structured layer 2, and it can be appropriately selected according to a particular application. From the perspective of preventing cracking during the pressing process in electrochemical element manufacturing, a frame shape, as illustrated in FIG. 3B, is preferred.

There are no specific restrictions on the size of the frame, and it can be appropriately selected according to a particular application. For example, it may be sized to surround the peripheral portion of the electrode composite layer in the electrochemical element.

The structured layer preferably has insulating properties. In the present specification, “having insulating properties” means that the volume resistivity of the structured layer is at least 1×10¹² (Ω·cm).

One method of imparting insulating properties to the structured layer includes adding insulating inorganic particles to the first liquid composition and the second liquid composition, for example.

### Storage Container

The storage container is a vessel in which a liquid composition is contained.

Specific examples of the vessel include, but are not limited to, a glass bottle, a plastic vessel, a plastic bottle, a stainless steel bottle, a 18-liter drum, and a drum.

### Other Processes and Other Devices

As for the other optional processes, there are no particular restrictions as long as they do not impair the effects of the present disclosure, and they can be appropriately selected according to a particular application. One specific process is a conveying process.

The other optional devices are not particularly limited and can be suitably selected to suit to a particular application unless it adversely impacts the effects of the present disclosure. It includes, for example, a conveying device.

### Conveying Process and Conveying Device

The conveying process is to convey the substrate. The conveying device is to convey the substrate.

The conveying process is suitably executed by the conveying device.

As for the conveying process and conveying device, there are no particular limitations as long as they are capable of carrying out conveyance from the first liquid composition application process to the first liquid composition polymerization process, from the second liquid composition application process to the second liquid composition polymerization process, and from the second liquid composition polymerization process to the structured layer formation process. They can be appropriately selected according to a particular application. Examples include, but atr not limited to, a sheet-fed system and a roll-to-roll (rotary) system.

Regarding the speed of the conveyance process and conveying device, from the viewpoint of productivity, a speed of 1 m/min to 100 m/min is preferable, and a speed of 30 m/min to 60 m/min is more preferable.

Embodiments of the present disclosure is described with reference to the drawings. The present disclosure is not limited to these embodiments.

In the drawings, identical components may be denoted by the same reference numerals (or symbols), and redundant descriptions may be omitted. Additionally, the present disclosure is not restricted to the specific numbers, positions, or shapes of the configurations described below. These parameters may be appropriately selected to suit the implementation of the present disclosure.

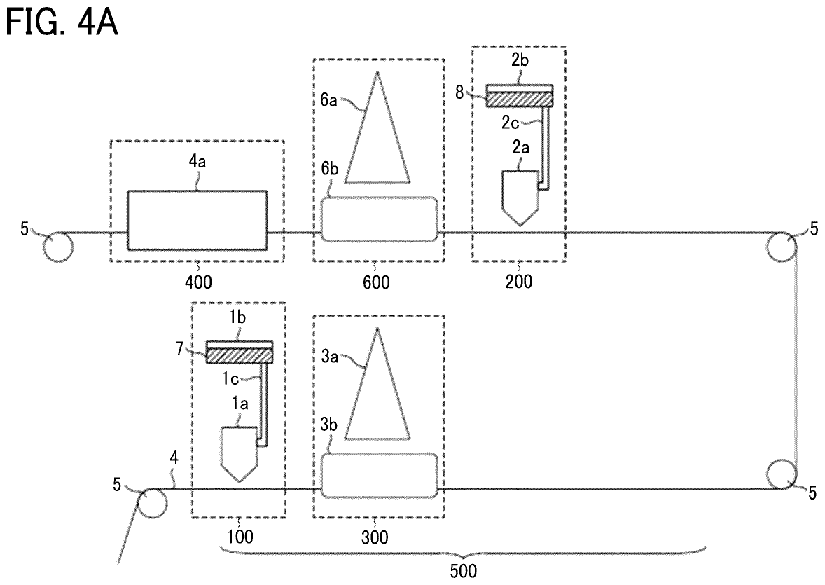

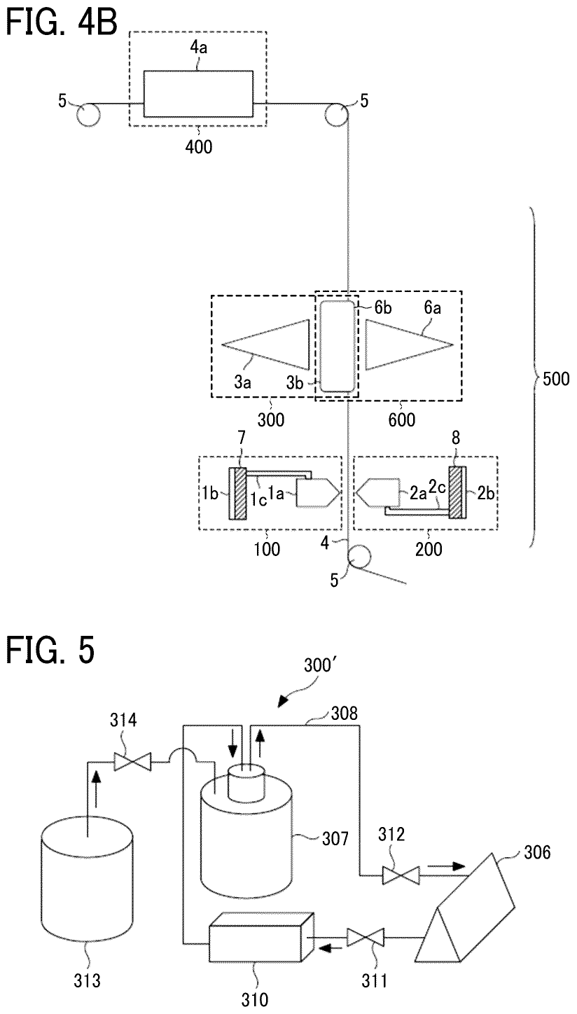

FIGS. 4A and 4B: Embodiments for Forming Structured Layer or Member for Electrode for Electrochemical Element by Applying Liquid Composition to Substrate

FIG. 4A is a schematic diagram illustrating the method of manufacturing a member for an electrochemical element according to an embodiment of the present disclosure.

FIG. 4B is a schematic diagram illustrating the method of manufacturing a member for an electrochemical element according to another embodiment of the present disclosure.

A device 500 for manufacturing a member for an electrochemical element manufactures a structured layer using a first liquid composition 7. The device 500 for manufacturing a member for an electrochemical element includes the following elements:
A first printing unit 100 that performs the first liquid composition application for applying a first liquid composition 7 onto the printing substrate 4 to form a first liquid composition film;
A second printing unit 200 that performs the second liquid composition application for applying a second liquid composition 8 to form a second liquid composition film;
A polymerization unit 300 that applies hear or light to the first liquid composition for performing the first liquid composition polymerization;
A polymerization unit 600 that applies heat or light to the second liquid composition film for performing the second liquid composition polymerization; and
A removing unit 400 that applies heat to the precursors of the structured layer to remove the solvent in the pores, thereby forming the structured layer.

The device 500 for manufacturing a member for an electrochemical element is equipped with a conveying unit 5 that conveys the printing substrate 4. The conveying unit 5 moves the printing substrate 4 at a predetermined speed in the following order of the first printing unit 100, the first polymerization unit 300, the second printing unit 200, the second polymerization unit 600, and the removing unit 400.

The printing substrate 4 is a substrate for a member for an electrochemical element.

### First Printing Unit 100

The first printing unit 100 includes:
A printing unit 1a that applies the first liquid composition 7 onto the printing substrate 4;
A storage container 1b that stores the first liquid composition 7; and
A supply tube 1c that supplies the first liquid composition 7 from the storage container 1b to the printing device 1a.

The storage container 1b stores the first liquid composition 7, and the printing unit 100 discharges the first liquid composition 7 from the printing device 1a, applying it onto the printing substrate 4. The storage container 1b may be configured in an integrated manner with a device for manufacturing a member for an electrochemical element. Alternatively, it can be configured removable from a device for manufacturing a member for an electrochemical element. In addition, the storage container 1b may be configured to be added to a container integrated with a device for manufacturing a member for an electrochemical element or a container detachable from a device for manufacturing a member for an electrochemical element.

The storage container 1b and the supply tube 1c can be freely-selected as long as the first liquid composition 7 can be stably stored and supplied. It is preferable that the materials constituting the storage container 1b and supply tube 1c have light-shielding properties in the range of ultraviolet and the relatively short wavelength regions of the visible light. Due to this light shielding property, the liquid composition 7 is prevented from starting being polymerized by external light.

### Second Printing Unit 200

The second printing unit 200 includes:
A printing device 2a that applies the second liquid composition 8 onto the printing substrate 4;
A storage container 2b that stored the second liquid composition 8; and
A supply tube 2c that supplies the second liquid composition 8 from the storage container 2b to the printing device 2a.

The storage container 2b stores the second liquid composition 8, and the second printing unit 200 discharges the second liquid composition 8 from the printing unit 2a, applying it onto the printing substrate 4. The storage container 2b may be configured in an integrated manner with a device for manufacturing a member for an electrochemical element.

Alternatively, it can be configured removable from a device for manufacturing a member for an electrochemical element. In addition, the storage container 1b may be configured to be added to a container integrated with a device for manufacturing a member for an electrochemical element or a container detachable from a device for manufacturing a member for an electrochemical element.

The storage container 2b and the supply tube 2c can be freely-selected as long as the second liquid composition 8 can be stably stored and supplied. It is preferable that the materials constituting the storage container 2b and supply tube 2c have light-shielding properties in the range of ultraviolet and the relatively short wavelength regions of the visible light. Due to this light shielding property, the liquid composition 8 is prevented from starting being polymerized by external light.

As illustrated in FIG. 4B, after sequentially or simultaneously performing the first printing unit 100 and the second printing unit 200, polymerization may be carried out by the polymerization units 300 and 600. Alternatively, as illustrated in FIG. 4A, the process may include the first printing unit 100, the first polymerization unit 300, the second printing unit 200, and the second polymerization unit 300 in this order.

### Polymerization Unit 300

In the case of photopolymerization, the first polymerization unit 300, as illustrated in FIGS. 4A and 4B, includes:
A light irradiation device 3a, which carries out the polymerization of the first liquid composition; and
A polymerization-inert gas circulation device 3b, which circulates polymerization-inert gas.

The light irradiation device 3a irradiates the first liquid composition film, formed by the printing unit 100, with light in the presence of polymerization-inert gas, inducing photopolymerization to obtain a precursor of the structured layer.

The light irradiation device 3a is appropriately selected depending on the absorption wavelength of the photopolymerization initiator contained in the first liquid composition layer and is not particularly limited as long as it can start and proceed the polymerization of the compound in the first liquid composition. For example, ultraviolet light sources such as a high-pressure mercury lamp, a metal halide lamp, a hot cathode tube, a cold cathode tube, and an LED can be used. However, since light having a shorter wavelength generally tends to reach a deep part, it is preferable to select a light source according to the thickness of the structured layer to be formed.

Next, regarding the irradiation intensity of the light source of the light irradiation device 3a, if the irradiation intensity is too strong, the polymerization proceeds rapidly before the phase separation sufficiently occurs, so that a porous structure tends to be difficult to obtain. In addition, if the irradiation intensity is too weak, the phase separation proceeds more than the microscale and the porous variation and the coarsening are likely to occur. In addition, the irradiation time becomes longer and the productivity tends to decline. Therefore, the irradiation intensity is preferably 10 mW/cm² to 1 W/cm² and more preferably from 30 to 300 mW/cm².

### Polymerization Unit 600

In the case of photopolymerization, the second polymerization unit 300, as illustrated in FIGS. 4A and 4B, includes:
A light irradiation device 3a, which carries out the polymerization of the second liquid composition; and
A polymerization-inert gas circulation device 6b, which circulates polymerization-inert gas.

The light irradiation device 6a irradiates the second liquid composition film, formed by the second printing unit 200, with light in the presence of polymerization-inert gas, inducing photopolymerization to obtain the structured layer.

The light irradiation device 6a is appropriately selected depending on the absorption wavelength of the photopolymerization initiator contained in the second liquid composition layer and is not particularly limited as long as it can start and proceed the polymerization of the compound in the second liquid composition. For example, ultraviolet light sources such as a high-pressure mercury lamp, a metal halide lamp, a hot cathode tube, a cold cathode tube, and an LED can be used. However, since light having a shorter wavelength generally tends to reach a deep part, it is preferable to select a light source according to the thickness of the porous film to be formed.

Next, regarding the irradiation intensity of the light source of the light irradiation device 6a, if the irradiation intensity is too strong, the polymerization proceeds rapidly before the phase separation sufficiently occurs, so that a porous structure tends to be difficult to obtain. In addition, when the irradiation intensity is too weak, the phase separation proceeds more than the microscale and the porous variation and the coarsening are likely to occur. In addition, the irradiation time becomes longer and the productivity tends to decline. Therefore, the irradiation intensity is preferably 10 mW/cm² to 1 W/cm² and more preferably from 30 to 300 mW/cm².

The polymerization inert gas circulation device 3b and the polymerization inert gas circulation device 6b play a role of reducing the polymerization active oxygen concentration contained in the atmosphere and allowing the polymerization reaction of the polymerizable compound near the surface of the liquid composition to proceed without inhibition. Therefore, the polymerization inert gas used is not particularly limited as long as it satisfies the function mentioned above. For example, nitrogen, carbon dioxide, and argon can be used.

It is preferable to maintain the O₂ concentration in the inert gas below 20 percent (a lower oxygen concentration than in the atmosphere) to achieve a greater inhibition reduction effect. More preferably, the O₂ concentration should be between 0 and 15 percent, and even more preferably between 0 and 5 percent. Additionally, it is preferable for the polymerization inert gas circulation device 3b and the polymerization inert gas circulation device 6b to be equipped with a temperature control device to ensure stable polymerization conditions.

The first polymerization unit 300 and the second polymerization unit 300 may be a heating device in the case of thermal polymerization. There are no particular limitations on the heating device, and it can be appropriately selected according to the purpose. Examples include, but are not limited to, substrate heating (such as hot plates), IR heaters, and hot air heaters, which may also be used in combination.

Additionally, the heating temperature and time, or the conditions for light irradiation, can be appropriately selected according to the polymerizable compounds contained in the first liquid composition 7 and the second liquid composition 8 and the thickness of the formed film.

### Removing Unit 400

As illustrated in FIGS. 4A and 4B, the removing unit 400 includes a heating device 4a. In the structured layer formation process, the precursor of the structured layer formed by the polymerization units 300 and 600 is heated by the heating device 4a to dry and remove the remaining solvent. The structured layer is thus formed. The removing unit 400 performs removing may be conducted under reduced pressure.

The removing unit 400 may also promote polymerization process, in which the precursor of the structured layer is heated by the heating device 4a to further promote the polymerization reaction carried out in the polymerization units 300 and 600. Additionally, it may perform initiator removal, in which the photopolymerization initiator remaining in the precursor of the structured layer is heated and dried by the heating device 4a. These polymerization promotion and initiator removal processes do not need to be conducted simultaneously with the structured layer formation; they may be performed before or after the structured layer formation.

FIG. 5

FIG. 5 is a schematic diagram illustrating the device (liquid discharging device) for manufacturing a member for an electrochemical element according to an embodiment of the present disclosure.

A liquid discharging device 300′ circulates the liquid compositions in a liquid discharging head 306, a tank 307, and a tube 308 by adjusting a pump 310 and valves 311 and 312.

The liquid discharging device 300′ is equipped with an external tank 313, allowing the liquid composition to be supplied from the external tank 313 to the tank 307 by adjusting the pump 310 and operating the valves 311, 312, and 314 if the liquid composition in the tank 307 decreases.

With such a device for manufacturing a member for an electrochemical element, the liquid composition can be discharged onto the target position.

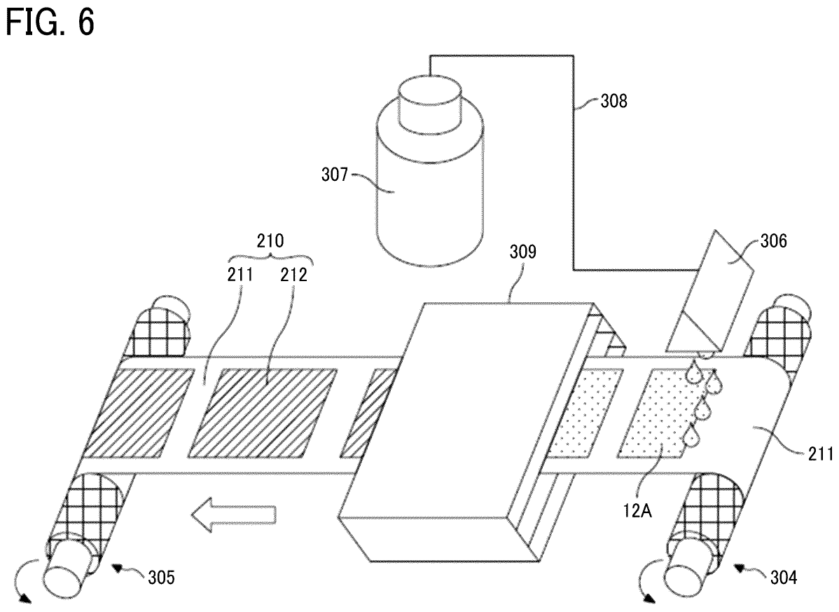

FIG. 6

FIG. 6 is a schematic diagram illustrating the device (liquid discharging device) for manufacturing a member for an electrochemical element according to another embodiment of the present disclosure.

The method of manufacturing a member 210 for an electrochemical element, which has a structured layer formed on a substrate, includes a process of sequentially discharging a liquid composition 12A onto a substrate 211 using the liquid discharging device 300′.

First, a slender substrate 211 is prepared. The substrate 211 is then wound around a cylindrical core, with the side where the structured layer 212 is to be formed facing upwards as illustrated in FIG. 6, and is placed between a feed roller 304 and a reeling roller 305. The feeding roller 304 and the reeling roller 305 rotate counterclockwise to convey the substrate 211 from the right to left in FIG. 6. The liquid discharging head 306 disposed above the substrate 211 between the feeding roller 304 and the reeling roller 305 discharges liquid droplets of the liquid composition 12A onto the substrate 211 sequentially conveyed in the same manner as illustrated in FIG. 6.

Next, the substrate 211, onto which the droplets of liquid composition 12A have been discharged, is conveyed to the polymerization unit 309 by the feed roller 304 and the reeling roller 305. As a result, the structured layer 212 is formed, and the member 210 for an electrochemical element, with the structured layer disposed on the substrate, is obtained. Thereafter, the member 210 is cut to a desired size by processing, such as punching.

Two or more of the liquid discharging heads 306 can be positioned in the direction substantially parallel or perpendicular to the conveyance direction of the substrate 211.

The polymerization unit 309 may be installed on either the upper or lower side of the substrate 211, or multiple units may be disposed.

The polymerization unit 309 is not particularly limited as long as it does not directly contact the liquid composition 12A. For example, in the case of thermal polymerization, options include resistance heating heaters, infrared heaters, and fan heaters, while in the case of photopolymerization, ultraviolet irradiation devices can be used.

There is no specific limitation to the conditions for heating or light irradiation. It can be selected to suit to a particular application. Due to polymerization, the liquid composition 12A is polymerized to form a structured layer.

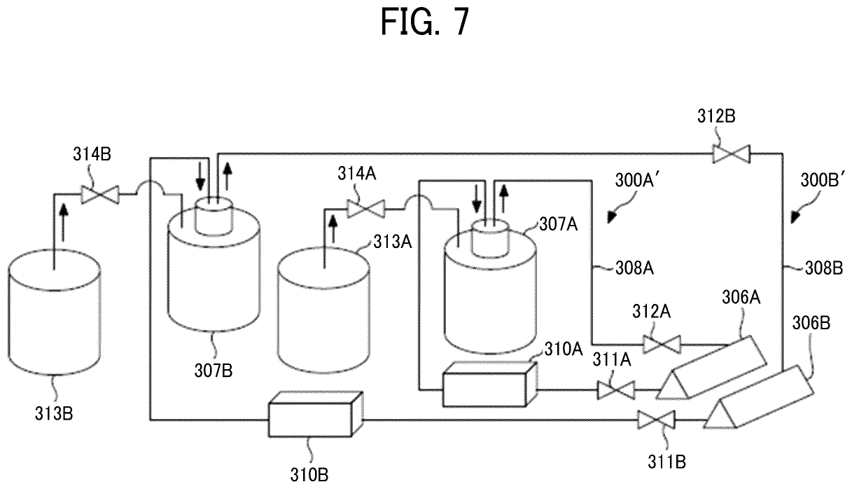

FIG. 7

FIG. 7 is a schematic diagram illustrating a variation of the device for manufacturing a member for an electrochemical element according to an embodiment of the present disclosure.

The liquid discharging devices 300A′ and a 300B′ may be used in combination. Specifically, the liquid composition may be supplied from external tanks 313A and 313B connected to the tanks 307A and 307B, respectively, and the liquid discharging heads may include multiple heads 306A and 306B. Additionally, the system may include tubes 308A and 308B, valves 311A, 311B, 312A, 312B, 314A, and 314B, as well as pumps 310A and 310B.

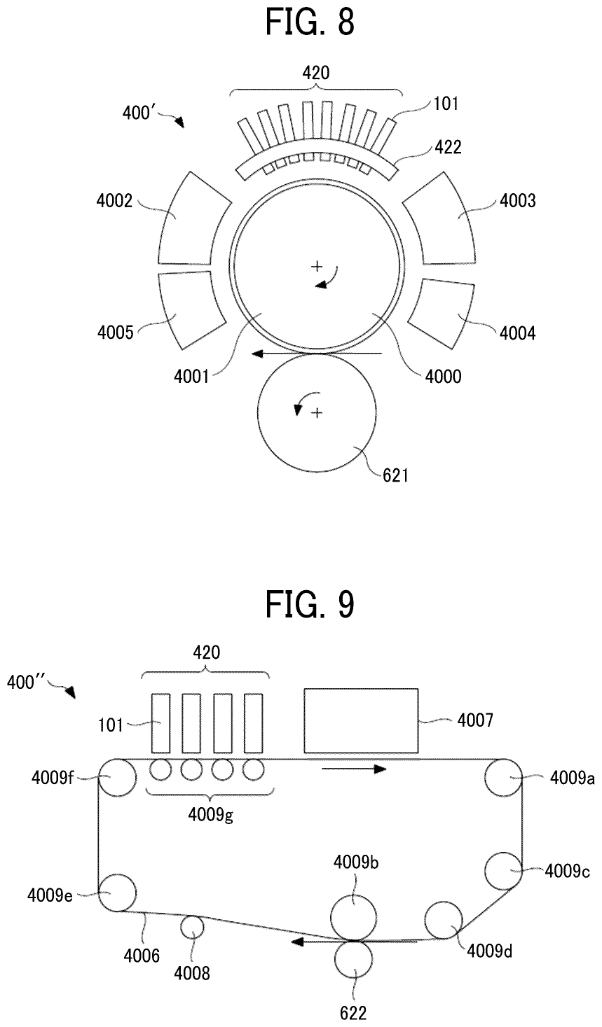

FIG. 8: Embodiments for Forming Structured Layer or Electrode for Electrochemical Element by Indirectly Applying Liquid Composition to Substrate

FIG. 8 is a diagram (part 1) illustrating a configuration of an example of the printing unit employing an inkjet method and transfer method as the liquid composition applying device in a device for manufacturing a member for an electrochemical element according to an embodiment of the present disclosure. In the printing unit illustrated in FIG. 8, a drum-shaped intermediate transfer body is used.

A printing unit 400′ is an inkjet printer that forms a structured layer on a substrate by transferring the liquid composition onto the substrate via an intermediate transfer member 4001.

The printing unit 400′ includes an inkjet unit 420, a transfer drum 4000, a pretreatment unit 4002, an absorption unit 4003, a heating unit 4004, and a cleaning unit 4005.

The inkjet unit 420 includes a head module 422 carrying multiple heads 101.

The heads 101 discharge a liquid composition to the intermediate transfer member 4001 supported by the transfer drum 4000 to form a liquid composition layer on the intermediate transfer member 4001. Each of the heads 101 is a line head. The nozzles thereof are disposed to cover the width of the printing region of the maximally usable substrate. The heads 101 have a nozzle surface formed with nozzles on its lower side, and the nozzle surface faces the surface of the intermediate transfer member 4001 through a minute gap. In the present embodiment, the intermediate transfer member 4001 is configured to move circularly on a circular orbit. The heads 101 are thus radially positioned.

The transfer drum 4000 faces an impression cylinder 621 and forms a transfer nip. The pretreatment unit 4002 may apply a reaction liquid to the intermediate transfer member 4001 to increase the viscosity of a liquid composition before the heads 101 discharge the liquid composition.

The absorption unit 4003 absorbs the liquid component from the liquid composition on the intermediate transfer member 4001 before transferring.

The heating unit 4004 heats the liquid composition on the intermediate transfer member 4001 before transferring. The structured layer is formed by heating the liquid composition. The solvent is also removed, thereby enhancing the transferability to the substrate.

The cleaning unit 4005 cleans the intermediate transfer member 4001 after the transfer process and removes ink and contaminants, such as dust, that remain on the intermediate transfer member 4001.

The outer surface of the impression cylinder 621 is in press contact with the intermediate transfer member 4001, allowing the insulating resin layer on the intermediate transfer member 4001 to be transferred to the substrate when it passes through the transfer nip between the impression cylinder 621 and the intermediate transfer member 4001. The impression cylinder 621 can be configured to include at least one gripping mechanism for holding the front end of the substrate on its outer surface.

FIG. 9

FIG. 9 is a diagram (part 2) illustrating a configuration of an example of the printing unit employing an inkjet method and transfer method as the liquid composition applying device in a device for manufacturing a member for an electrochemical element according to an embodiment of the present disclosure. The printing unit 9 has an intermediate transfer member having an endless belt form.

A printing unit 400″ is an inkjet printer that forms a structured layer by transferring the liquid composition onto a substrate via an intermediate transfer belt 4006.

The printing unit 400″ is equipped with an inkjet unit 420, a transfer roller 622, the intermediate transfer belt 4006, a heating unit 4007, a cleaning roller 4008, a drive roller 4009a, a counter roller 4009b, a shape-maintaining roller 4009c, a shape-maintaining roller 4009d, a shape-maintaining roller 4009e, and a shape-maintaining roller 4009f.

The printing unit 400″ discharges liquid droplets of the liquid composition from the heads 101 of the inkjet unit 420 onto the outer surface of the intermediate transfer belt 4006. The liquid composition on the intermediate transfer belt 4006 is heated by the heating unit 4007 and forms a structured layer through thermal polymerization. The structured layer on the intermediate transfer belt 4006 is transferred to the substrate at the transfer nip where the intermediate transfer belt 4006 faces the transfer roller 622. After transfer, the cleaning roller 4008 cleans the surface of the intermediate transfer belt 4006.

The intermediate transfer belt 4006 is stretched over a drive roller 4009a, a counter roller 4009b, multiple shape-maintaining rollers 4009c, 4009d, 4009e, 4009f, and several support rollers 4009g, and moves in the direction indicated by the arrow in FIG. 9. The support rollers 4009g disposed facing the heads 101 maintain the tension of the intermediate transfer belt 4006 when the heads 101 discharge the liquid composition.

### Electrochemical Element

The member for an electrochemical element obtained by the method of manufacturing the present disclosure can be suitably applied to the electrode of an electrochemical element.

The electrochemical element of the present disclosure includes a member for an electrochemical element and may also optionally include external packaging and other components.

As for the outer casing, there is no particular limitation as long as it can seal the electrode laminate, and a known outer casing can be appropriately selected according to a particular application.

The shape of the electrochemical element is not particularly limited.

Examples include, but are not limited to, a laminate shape of flat electrodes, a cylindrical shape in which a sheet electrode and a separator are formed in a spiral manner, a cylindrical shape having an inside-out structure in which a pellet electrode and a separator are combined, and a coin shape in which a pellet electrode and a separator are stacked.

### Electrode

The electrode includes an electrode substrate, an electrode composite layer provided on the electrode substrate, and an insulating layer provided at the outer periphery of the electrode composite layer. It may furthermore optionally other members.

Since the electrode can be obtained using the electrochemical element member produced by the method described in Method of Manufacturing Member for Electrochemical Element and Apparatus for Manufacturing Member for Electrochemical Element, redundant descriptions are omitted. In other words, in Method of Manufacturing Member for Electrochemical Element and Apparatus for Manufacturing Member for Electrochemical Element, the “substrate” corresponds to the “electrode substrate” in the electrode, and the “insulating and frame-shaped structured layer” corresponds to the “insulating layer” in the electrode.

In the present specification, the positive electrode and negative electrode may be referred to as “electrode,” the positive electrode substrate and negative electrode substrate may be referred to as “electrode substrate,” and the positive electrode composite layer and negative electrode composite layer may be referred to as “electrode composite layer.”

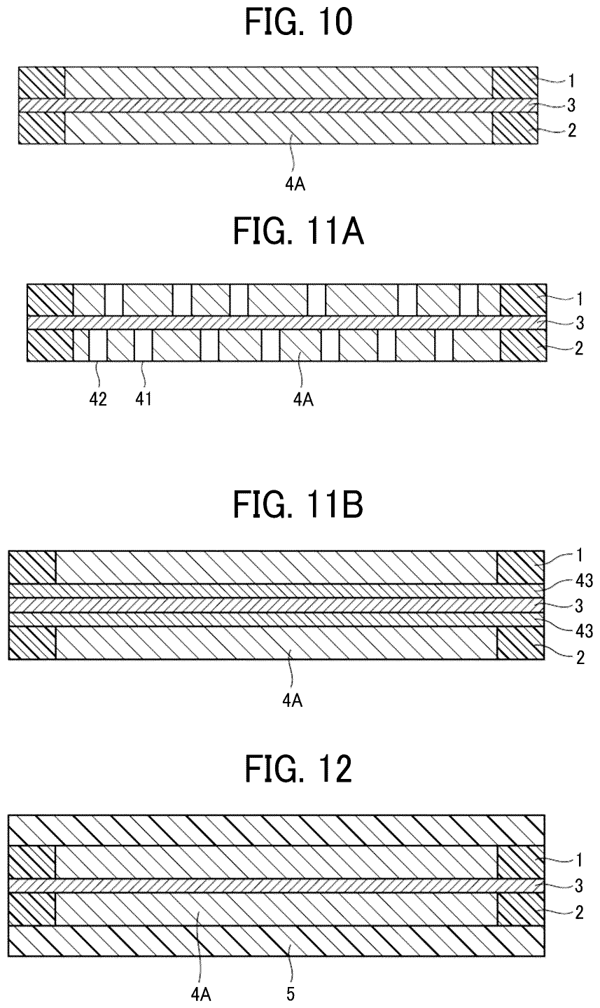

FIG. 10

FIG. 10 is a schematic cross-sectional view illustrating another embodiment of the cleaning blade of the present disclosure.

The electrode includes an electrode substrate 3, an electrode composite layer 4A disposed on the electrode substrate 3, a first insulating layer 1 formed from a first insulating layer-forming liquid composition and disposed at the outer periphery of the electrode composite layer 4A, and a second insulating layer 2 formed from a second insulating layer-forming liquid composition.

### Electrode Substrate

The electrode substrate can be the same as those described in Substrate.

### Electrode Composite Layer

The electrode composite layer is disposed on the electrode.

The electrode composite layer (also referred to as the active material layer) is primarily made of an active material (either a negative electrode active material or a positive electrode active material). In the present specification, primarily made of an active material means that the active material content is at least 70 percent by mass of the entire electrode composite layer.

The electrode composite layer is formed of a liquid composition for forming an electrode composite layer.

There are no particular restrictions on the liquid composition for forming an electrode composite layer, and it can be appropriately selected according to a particular application. For example, it may contain an active material (either a negative electrode active material or a positive electrode active material). The liquid composition may furthermore optionally contain a conductive additive, binder for the electrode composite layer, dispersant for the electrode composite layer, solid electrolyte, gel electrolyte, solvent for the electrode composite layer, and other components.

### Active Material

The active material can be either a positive electrode active material or a negative electrode active material. The positive electrode active material or negative electrode active material may be used alone or in combination of two or more.

### Positive Electrode Active Material

There is no particular limitation on the positive electrode active material as long as it is a material capable of reversibly absorbing and releasing alkali metal ions. For example, alkali metal-containing transition metal compounds can be used as the positive electrode active materials.

Specific examples of alkali metal-containing transition metal compounds include, but are not limited to, lithium-containing transition metal compounds such as composite oxides containing lithium and one or more elements selected from the group consisting of cobalt, manganese, nickel, chromium, iron, and vanadium.

Specific examples of lithium-containing transition metal compounds include lithium cobalt oxide, lithium nickel oxide, and lithium manganese oxide.

Alkali metal-containing transition metal compounds may also include polyanion compounds having an XO₄ tetrahedron (where X═P, S, As, Mo, W, Si, etc.) in their crystal structure. Of these, lithium-containing transition metal phosphate compounds such as lithium iron phosphate and lithium vanadium phosphate are preferable in terms of cyclability. Lithium vanadium phosphate is more preferable in terms of lithium diffusion coefficient and output properties.

As for the polyanion compounds, it is preferable that the surface is coated and compounded with conductive additives such as carbon materials to enhance electronic conductivity.

It is preferable for alkali metal-containing transition metal compounds to be at least partially coated with an ion-conductive oxide on their surface. As the ion-conductive oxide, lithium ion-conductive oxides are preferable.

There are no particular limitations on the selection of lithium ion-conductive oxides, which can be selected according to a particular application.

Specific examples include, but are not limited to, oxides represented by Chemical Formula LiₓAO_{y} (where A represents B, C, Al, Si, P, S, Ti, Zr, Nb, Mo, Ta, Sc, V, Y, Ca, Sr, Ba, Hf, Ta, Cr, or W, and x and y are positive numbers).

Specific examples of lithium ion-conductive oxides include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₂O₁₂, Li₂Ti₂O₅, Li₂ZrO₃, LiNbO₃, LiTaO₃, Li₂MoO₄, and Li₂WO₄. Among these, Li₄Ti₅O₁₂, Li₂ZrO₃, or LiNbO₃ is preferable.

Lithium ion-conductive oxides may also be composite oxides. Any combination of lithium ion-conductive oxides may be used as composite oxides, such as Li₄SiO₄—Li₃BO₃ and Li₄SiO₄—Li₃PO₄.

### Negative Electrode Active Material

As for the negative electrode active material, there are no particular limitations as long as it is a material capable of reversibly absorbing and releasing alkali metal ions, and it can be appropriately selected according to a particular application.

For example, carbon materials containing graphite with a graphite-type crystalline structure can be used.

Examples of carbon materials include, but are not limited to, natural graphite, spherical or fibrous artificial graphite, hard carbon (non-graphitizable carbon), and soft carbon (easily graphitizable carbon).

In addition to carbon materials, examples of other materials include, but are not limited to, lithium titanate and titanium oxide.

High-capacity materials such as silicon, tin, silicon alloys, tin alloys, silicon oxide, silicon nitride, and tin oxide can also be suitably used as negative electrode active materials to increase the energy density of lithium-ion batteries.

### Conductive Assistant

The conductive assistant is not particularly limited and can be suitably selected to suit to a particular application. Examples of the conductive assistant include, but are not limited to, carbon black produced by a method such as a furnace method, an acetylene method, and a gasification method, and carbon materials such as carbon nanofibers, carbon nanotubes, graphene, and graphite particles.

Conductive assistants other than the carbon materials include, but are not limited to, metal particles and metal fiber of aluminum. The conductive assistant may be combined with an active material in advance.

The content of the conductive assistant to an active material is not particularly restricted and can be adjusted according to a particular application. It is preferable for the content to be at most 10 percent by mass, with a more preferable range of at most 8 percent by mass.

A content of the conductive assistant to an active material of at most 10 percent by mass is suitable for enhancing the stability of the liquid composition for forming an electrode composite layer.

A content of the conductive assistant to an active material of at most 8 percent by mass is suitable for further enhancing the stability of the liquid composition for forming an electrode composite layer.

### Binder for Electrode Composite Layer

As long as the binder for an electrode composite layer can bind the negative electrode materials to each other, the positive electrode materials to each other, the negative electrode materials to the negative electrode substrate, and the positive electrode materials to the positive electrode substrate, it is not particularly limited and can be appropriately selected according to a particular application. If the liquid composition for forming the electrode composite layer is used for inkjet discharging, it is preferable that the binder for an electrode composite layer minimally increase the viscosity of the liquid composition for forming the electrode composite layer, to minimize nozzle clogging in the liquid discharging head.

In the present specification, the binder or the binder for an insulating layer in the liquid composition for forming the insulating layer is distinguished from the binder for an electrode composite layer in the liquid composition for forming the electrode composite layer.

As the binder for forming an electrode composite layer, polymer compounds can be used.

Examples include, but are not limited to, thermoplastic resins such as polyvinylidene fluoride (PVDF), acrylic resin, polyethylene, polypropylene, polyurethane, nylon, polytetrafluoroethylene, polyphenylene sulfide, polyethylene terephthalate, polybutylene terephthalate, polyamide compounds, polyimide compounds, polyamide-imide, ethylene-propylene-butadiene rubber (EPBR), styrene-butadiene rubber (SBR), nitrile butadiene rubber (NBR), isoprene rubber, polyisobutene, polyethylene glycol (PEO), polymethyl methacrylate (PMMA), and polyethylene vinyl acetate (PEVA).

The content of the binder for forming an electrode composite layer to an active material is not particularly restricted and can be appropriately set depending on the purpose. It is preferable that the content be between 1 percent by mass and 15 percent by mass, with a more preferable range between 3 percent by mass and 10 percent by mass. If the content of the binder for forming an electrode composite layer to an active material is at least 1 percent by mass, it is suitable for strongly binding the active material to the substrate.

### Dispersant for Electrode Composite Layer

As long as it can improve the dispersibility of the active material within the liquid composition for forming the electrode composite layer, the dispersant for the electrode composite layer is not particularly restricted.

Examples include, but are not limited to, polymer dispersants such as polyethylene oxide, polypropylene oxide, polycarboxylic acid, naphthalene sulfonic acid formalin condensates, polyethylene glycol, polycarboxylic acid partial alkyl esters, polyether, and polyalkylene polyamine; low molecular weight dispersants such as alkyl sulfonic acid, quaternary ammonium alkylene oxide of higher alcohols, polyvalent alcohol esters, and alkyl polyamines; and inorganic dispersants such as polyphosphate-based dispersants.

In the present specification, the term dispersant or “dispersant for an insulating layer” in the liquid composition for forming the insulating layer is distinguished from the term “dispersant for an electrode composite layer” in the liquid composition for forming the electrode composite layer.

### Solid Electrolyte

As long as it is a solid substance that possesses electronic insulation and exhibits ionic conductivity, there are no particular restrictions on the solid electrolyte. Sulfide solid electrolytes and oxide solid electrolytes are preferred to achieve high ionic conductivity.

Examples of sulfide solid electrolytes include, but are not limited to, Li₁₀GeP₂S₁₂ and Li₆PS₅X (X═F, Cl, Br, I) with an argyrodite-type crystal structure.

Examples of oxide solid electrolytes include, but are not limited to, LLZ (Li₇La₃Zr₂O₁₂) with a garnet-type crystal structure, LATP (Li₁₊ₓAlₓTi₂₋ₓ(PO₄)₃) (0.1≤x≤0.4) with a NASICON-type crystal structure, LLT (Li_{0.33}La_{0.55}TiO₃) with a perovskite-type crystal structure, and amorphous LIPON (Li_{2.9}PO_{3.3}N_{0.4}).

These solid electrolytes can be used either alone or in combination of two or more types.

If the electrode composite layer is a positive electrode composite layer, there are no particular restrictions on its average thickness, and it can be appropriately selected depending on the purpose. A thickness of 10 μm to 300 μm is preferable, and a thickness of 40 μm to 150 μm is more preferable.

If the average thickness of the positive electrode composite layer is at least 10 μm, the energy density of the electrochemical element increases.

If the average thickness of the positive electrode composite layer is at most 300 μm, the load properties of the electrochemical element are improved.

If the electrode composite layer is a negative electrode composite layer, there are no particular restrictions on its average thickness, and it can be appropriately selected depending on the purpose. A thickness of 10 μm to 450 μm is preferable, and a thickness of 20 μm to 100 μm is more preferable.

If the average thickness of the negative electrode composite layer is at least 10 μm, the energy density of the electrochemical element increases.

If the average thickness of the negative electrode composite layer is at most 450 μm, the cycle performance of the electrochemical element are improved.

One embodiment of the electrode relating to the present disclosure are described with reference to the drawings. The present disclosure is not limited to these embodiments.

FIGS. 11A to 11B

FIG. 11A is a schematic cross-sectional view illustrating another embodiment of the electrode of the present disclosure. FIG. 11B is a schematic cross-sectional view illustrating one embodiment of an electrode according to the present disclosure.

The electrode composite layer may have an opening 41 as illustrated in FIG. 11A.

The number of openings 41 is preferably one or more, and more preferably multiple.

The opening 41 may penetrate the electrode composite layer 4A from the surface of the electrode composite layer to the surface of the electrode substrate, or it may not penetrate to the surface of the electrode substrate.

The opening 41 may be hollow or filled with a material 42. If the opening 41 is filled with the material 42, the material 42 may be a single substance or a mixture of two or more substances, but in either case, the material 42 should be different in nature from the material constituting the electrode composite layer. The material 42 preferably contains a solid electrolyte to improve the ionic conductivity.

An electrode composite layer with the opening 41 can be suitably manufactured using inkjet as an electrode composite layer forming device because coating control is easy.

Furthermore, as illustrated in FIG. 11B, the electrode composite layer 4A may have an adhesive layer 43 containing a metal that forms an alloy with lithium between the first substrate 3 and the first electrode composite layer 4A.

### Insulating Layer

The insulating layer is disposed on the outer periphery of the electrode composite layer.

The insulating layer is formed from the liquid composition for forming the insulating layer.

The liquid composition for forming the insulating layer contains the first liquid composition and the second liquid composition in Method of Manufacturing Member for Electrochemical Element and Device for Manufacturing Member for Electrochemical Element. It may furthermore optionally contain insulating inorganic particles, a dispersant for the insulating layer, a binder for the insulating layer, a solvent for the insulating layer, and other necessary components.

In the present specification, “disposed at the outer periphery of the electrode composite layer” means that the insulating layer may be placed along at least two sides, three sides, or all four sides of the outer periphery of the electrode composite layer. Additionally, the insulating layer may include recesses or notches on any side to allow the electrode tab to protrude.

### Insulating Inorganic Particles

There are no particular restrictions on the insulating inorganic particles as long as they have a volume resistivity of at least 10⁸ Ω·cm, and they can be appropriately selected depending on the purpose. Examples include, but are not limited to, aluminum oxide (alumina), boehmite, silica, aluminum nitride, silicon nitride, cordierite, sialon, mullite, steatite, yttria, zirconia, and silicon carbide. Among these, inorganic oxides are preferred. From the perspective of heat resistance, aluminum oxide and boehmite are more preferred, with a-alumina being the most preferred.

α-alumina is known to function as a scavenger for ‘junk’ chemical species, which can cause capacity fade in lithium-ion secondary batteries. Additionally, alumina particles exhibit excellent wettability and affinity with electrolytes, improving the cycle performance of lithium-ion secondary batteries. By using a-alumina as the insulating inorganic particles, the insulating layer-forming liquid composition benefits from improved redispersibility and inkjet discharging properties, while the insulating layer itself gains enhanced heat resistance.

These insulating inorganic particles can be used alone or in a combination of two or more thereof.

There are no particular restrictions on the shape of the insulating inorganic particles, and they can be selected as appropriate depending on the intended purpose. Examples include rectangular, spherical, elliptical, cylindrical, egg-shaped, dog-bone-shaped, and amorphous forms. Among these, from the viewpoint of improving inkjet discharging properties, it is preferable that the aspect ratio of the long and short axes of the insulating inorganic particles be close to 1.

There are no particular restrictions on the median diameter of the insulating inorganic particles, and it can be appropriately selected according to a particular application. It is preferably between 200 nm and 1,000 nm.

If the median diameter of the insulating inorganic particles is at least 200 nm, it helps prevents the particles from dispersing into the air (mist formation) during inkjet discharging. Additionally, in the insulating layer, it helps prevent the insulating inorganic particles from attaching onto the substrate due to the loss of fine particles.

If the median diameter of the insulating inorganic particles is at most 1,000 nm, it helps prevent nozzle clogging during inkjet discharging, thereby improving discharging performance. Furthermore, in the insulating layer, it promotes uniform thickness and homogenization (reducing irregularities), making it preferable.

There are no particular restrictions on the method of measuring the median diameter of the insulating inorganic particles, and it can be appropriately selected according to a particular application. Examples include, but are not limited to, dynamic light scattering, photon correlation spectroscopy, laser diffraction, centrifugal sedimentation, and induced diffraction methods. More specifically, after diluting the liquid composition so that the solid content is at most 10 percent by mass, the measurement can be performed using a high-concentration particle size analyzer (FPAR-1000, available from Otsuka Electronics Co., Ltd.).

It is preferable that the insulating inorganic particles contain a first insulating inorganic particle with a median diameter of 200 nm to less than 1,000 nm, and a second insulating inorganic particle with an average Stokes diameter of less than 30 nm. The average Stokes diameter refers to the average major axis length of the particles, measured by Transmission Electron Microscopy (TEM).

If the second insulating inorganic particle with an average Stokes diameter of less than 30 nm are contained, the energy barrier in the potential energy of interparticle interactions can be sufficiently reduced. This helps resolve issues where, after long-term standing of the liquid composition, the inorganic particles aggregate and are not redispersed even upon re-stirring.

There are no particular restrictions on the content of insulating inorganic particles, and it can be appropriately selected according to a particular application. In order to ensure the insulating layer after drying has a uniform thickness, it is preferable that the insulating layer forming liquid composition contain at least 10 percent by mass, and more preferably at least 20 percent by mass of the insulating inorganic particles. From the perspective of viscosity, it is preferable that the total content of the insulating inorganic particles in the insulating layer forming liquid composition does not exceed 60 percent by mass, and for better inkjet discharging properties, it is more preferable that it do not exceed 55 percent by mass.

The insulating inorganic particles can be synthesized or procured.

Specific examples of the commercially available aluminum oxide products that can be used as the insulating inorganic particles include, but are not limited to, High-purity alumina (available from Sumitomo Chemical Co., Ltd.): AKP-15, AKP-20, AKP-30, AKP-50, AKP-53, AKP-700, AKP-3000, AA-03, AA-04, AA-05, AA-07, AA-1.5, AKP-G07, and AKP-G15; TM-DA, TM-DAR, and TM-5D, (all available from TAIMEI CHEMICALS Co., Ltd.; CT-3000 LSSG, available from Almatis; LS-502, LS-711CB, and SLS-710, available from Nippon Light Metal Company, Ltd.; SEPal-60, and SEPal-70, available from Alteo.

One specific commercially available boehmite product that can be used as the insulating inorganic particles is BMB-07, available from KAWAI LIME INDUSTRY Co., Ltd.

### Other Optional Components

The insulating layer forming liquid composition may also include other components for purposes such as viscosity adjustment, particle size adjustment, surface tension control, evaporation control of non-aqueous solvents, improved solubility of additives, enhanced particle dispersibility, and sterilization. These components may include surfactants, pH adjusters, rust inhibitors, preservatives, antifungal agents, antioxidants, anti-reducing agents, evaporation accelerators, and chelating agents.

There are no particular restrictions on the content of these other components, and it can be appropriately set according to the content of various components in the insulating layer forming liquid composition.

There are no particular restrictions on the average thickness of the insulating layer, and it can be appropriately selected according to various conditions such as the average thickness of the electrode composite layer. It is preferably 1.0 μm to 150.0 μm, and more preferably 10.0 μm to 100.0 μm.

An average thickness of the insulating layer of at least 10.0 μm can suitably distribute the pressure load during pressing and prevent short circuits between the positive and negative electrodes.

If the average thickness of the insulating layer is at most 100.0 μm, it is possible to manufacture an electrochemical element with high density and excellent battery characteristics.

There are no particular restrictions on the compression ratio of the insulating layer (structured layer) after pressing at 500 MPa for 5 minutes, and it can be appropriately selected depending on the purpose. It is preferably between 1 percent and 50 percent, and more preferably between 5 percent and 20 percent.

A compression ratio of the strength of the insulating layer (structured layer) of at most 50 percent ensures adequate shape retention after the pressing process.

A compression ratio of the insulating layer of the insulating layer (structured layer) of at least 1 percent alleviates the pressure on the solid electrolyte layer from the insulating layer (structured layer) during the pressing process after the solid electrolyte layer is formed.

It is preferable for the insulating layer (structured layer) to have a co-continuous structure.

If the insulating layer (structured layer) has a co-continuous structure, it allows for precise and easy thickness control of the insulating layer (structured layer) through pressing, especially when its thickness is made approximately equal to that of the electrode composite layer. Additionally, the thickness of the insulating layer (structured layer) can also be easily controlled by forming it using the polymerization-induced phase separation method. If the insulating layer (structured layer) is a porous co-continuous structure, it can efficiently disperse the pressure generated during pressing. This structure helps prevent issues such as damage to the insulating layer (structured layer), uneven surface height variations, and other defects, thereby ensuring a high-quality insulating layer (structured layer).

In electrochemical devices where short circuits can potentially occur due to dendrite deposition, it is generally common to configure the negative electrode composite layer to be larger than the positive electrode composite layer. In this case, if the positive and negative current collectors are approximately the same size, a surplus area where the positive electrode composite layer is not formed will be present in the region on the positive current collector where it faces the negative electrode composite layer. From the perspective of electrochemical element properties, it is preferable for the insulating layer (structured layer) to be disposed on the excess portion of the positive electrode, that is, on the outer peripheral portion of the positive electrode composite layer. However, if the electrochemical element is designed such that the negative electrode composite layer is smaller than the positive electrode composite layer, then it is preferable for the insulating layer (structured layer) to be disposed on the excess portion of the negative electrode, that is, on the outer peripheral portion of the negative electrode composite layer.

### Solid Electrolyte Layer

The electrochemical element is preferably an all solid electrode with a solid electrolyte layer.

There are no particular restrictions on the solid electrolyte, and it can be appropriately selected according to a particular application. The solid electrolyte described in Solid Electrolyte may be used.

The solid electrolyte layer is formed from a solid electrolyte layer forming liquid composition.

The liquid composition for forming a solid electrolyte layer may contain a binder for the solid electrolyte layer.

Examples include, but are not limited to, thermoplastic resins such as polyvinylidene fluoride (PVDF), acrylic resin, styrene-butadiene rubber, polyethylene, polypropylene, polyurethane, nylon, polytetrafluoroethylene, polyphenylene sulfide, polyethylene terephthalate, polybutylene terephthalate, polyamide compounds, polyimide compounds, polyamide-imide, ethylene-propylene-butadiene rubber (EPBR), styrene-butadiene rubber (SBR), nitrile-butadiene rubber (NBR), polymethyl methacrylate (PMMA), polybutyl methacrylate (PBMA), isoprene rubber, polyisobutene, polyethylene glycol (PEO), and polyethylene vinyl acetate (PEVA).

FIG. 12

FIG. 12 is a schematic cross-sectional view illustrating another embodiment of the electrode of the present disclosure.

The electrode includes the electrode substrate 3, the electrode composite layer 4A disposed on the electrode substrate 3, the first insulating layer 1 formed from the liquid composition for forming the first insulating layer and disposed at the outer periphery of the electrode composite layer 4A, the second insulating layer 2 formed from the liquid composition for forming the second insulating layer, and a solid electrolyte layer 5 disposed on the electrode composite layer 4A, the first insulating layer 1, and the second insulating layer 2.

### Method of Manufacturing Electrode and Apparatus for Manufacturing Electrode

The method of manufacturing an electrode relating to the present disclosure includes forming an insulating resin layer, forming an electrode composite layer, removing the solvent, and other optional processes.

The apparatus for manufacturing an electrode relating to the present disclosure includes a storage container, a device for forming the insulating layer, a device for forming the electrode composite layer, a device for removing solvent and other optional devices.

The insulating layer formation process (or device) and the solvent removal process (or device) may be the same as those described in Method of Manufacturing Member for Electrochemical Element and Apparatus for Manufacturing Member for Electrochemical Element, except that the liquid composition for forming an insulating layer is used as the first and second liquid compositions. Therefore, redundant descriptions are omitted.

Process of Forming Insulating Layer and Device for Forming Insulating Layer The process of forming an insulating layer is to form an insulating layer on am electrode substrate. The process of forming an insulating layer preferably includes application of a liquid composition for forming an insulating layer, and curing of a liquid composition for forming an insulating layer.

The device for forming an insulating layer forms an insulating layer on am electrode substrate. The device for forming an insulating layer preferably includes a device for applying a liquid composition for forming the insulating layer, and a device for curing a liquid composition for forming the insulating layer.

The process of forming an insulating layer can be suitably carried out by the device for forming an insulating layer, the process of applying a liquid composition can be suitably carried out by device for applying the liquid composition, and the process of polymerizing the liquid composition can be suitably carried out by the device for polymerizing the liquid composition for forming the insulating layer.

### Process of Applying Liquid Composition for Forming Insulating Layer and Device for Applying Liquid Composition for Forming Insulating Layer

In the application of a liquid composition for forming an insulating layer, a liquid composition for forming an insulating layer is applied to an electrode substrate.

The device for applying a liquid composition for forming an insulating layer applies a liquid composition for forming an insulating layer to an electrode substrate.

### Process of Polymerizing Liquid Composition for Forming Insulating Layer and Device for Polymerizing Liquid Composition

In the process of polymerizing a liquid composition for forming an insulating layer, the liquid composition for forming an insulating layer that is applied is polymerized.

The device for polymerizing the liquid composition for forming the insulating layer polymerizes the liquid composition for forming an insulating layer that is applied.

### Process of Forming Electrode Composite Layer and Device for Forming Electrode Composite Layer

The process of forming an electrode composite layer is to form an electrode composite layer on an electrode substrate.

The device for forming an electrode composite layer is to form an electrode composite layer on an electrode substrate.

There are no particular limitations on the process of and the device for forming an electrode composite layer, and they can be appropriately selected according to a particular application. For example, one method of applying a liquid composition for an electrode mixture layer onto an electrode substrate, followed by fixing and drying, can be used. In this process, application methods such as spraying, dispensing, die coating, or dip coating can be suitably employed.

### Process of Removing Solvent and Device for Removing Solvent

In the process of removing a solvent, the solvent is removed from the polymerized liquid composition for forming an insulating layer.

The device for removing a solvent removes the solvent from the polymerized liquid composition for forming an insulating layer.

The process of removing a solvent and the device for removing the solvent correspond to the process of forming a structured layer and the device for forming the structured layer, respectively.

In the method of manufacturing an electrode, there are no particular restrictions on the order of the insulating layer formation and the electrode composite layer formation. Specifically, the process of forming an electrode composite layer may be performed before the process of forming an insulating layer, with the insulating layer being formed around the outer periphery of the electrode composite layer after its formation. In this case, the method of manufacturing an electrode involves performing the electrode composite layer formation, the insulating layer formation, and then the solvent removal in that order.

Similarly, the electrode composite layer may be formed after the insulating layer formation, with the insulating layer having a frame-like shape being formed around the outer periphery of the electrode substrate, and then the electrode composite layer being formed inside the insulating layer. In this case, the method of manufacturing an electrode involves performing the insulating layer formation, the electrode composite layer formation, and then the solvent removal in that order.

### Method of Manufacturing Electrode Laminate and Device for Manufacturing Electrode Laminate

The method of manufacturing an electrode laminate according to the present disclosure includes a process of manufacturing an electrode manufactured by a method of manufacturing an electrode and a process of forming a solid electrolyte layer, and may furthermore optionally include a pressing process and other processes.

The device for manufacturing an electrode laminate according to the present disclosure includes a device for manufacturing an electrode and a device for forming a solid electrolyte layer, and may furthermore optionally include a pressing device and other devices.

The process (or device) of manufacturing an electrode may be the same as Method of Manufacturing Electrode and Device for Manufacturing Electrode, and therefore, redundant descriptions are omitted.

### Process of Forming Solid Electrolyte Layer and Device for Forming Solid Electrolyte Layer

The process of forming a solid electrolyte layer involves forming a solid electrolyte layer on both of the electrode composite layer and the structured layer.

The device for forming a solid electrolyte layer involves forming a solid electrolyte layer on both of the electrode composite layer and the structured layer.

The process of forming a solid electrolyte layer can be suitably carried out using the device for forming a solid electrolyte layer.

There are no particular limitations on the method of and the device for forming the solid electrolyte layer, and it can be appropriately selected according to a particular application. For example, one way of forming the solid electrolyte involves applying a liquid composition for forming a solid electrolyte layer containing a solid electrolyte and an optional binder for a solid electrolyte layer, onto the electrode composite layer and the structured layer, followed by drying through solidification.

The method of and the device for forming a solid electrolyte layer are not particularly limited and they can be suitably selected to suit to a particular application.

Specific examples include, but are not limited to, liquid discharging methods such as an inkjet method, a spray coating method, and a dispenser method, spin coating, casting, MICROGRAVURE™ coating, gravure coating, bar coating, roll coating, wire bar coating, dip coating, slit coating, capillary coating, nozzle coating, gravure printing, screen printing, flexographic printing, offset printing, and reverse printing.

### Pressing Process and Pressing Device

The pressing process is to press the electrode composite layer and insulating layer.

The pressing device presses the electrode composite layer and insulating layer.

The pressing process is suitably executed by the pressing device.

Regarding the pressing process and device, there are no particular restrictions; it can be performed using commercially available pressure molding equipment. The electrode composite layer and the insulating resin layer are possibly pressed in the substrate direction. Examples include, but are not limited to, uniaxial presses, roll presses, cold isostatic presses (CIP), and hot presses. Among these, cold isostatic presses (CIP), which can apply isotropic pressure, are preferred.

There are no particular restrictions on the timing of the pressing process; it can be appropriately selected according to a particular application. For example, the electrode composite layer and the insulating layer can be pressed after being formed on the substrate, or the pressing can be done after the solid electrolyte layer has been provided, or at both timings if the thickness of the structured layer before pressing are substantially equal to that of the electrode composite layer.

Carrying out the pressing process after forming the electrode composite layer and the insulating layer on the substrate, but before forming the solid electrolyte layer, makes the average thickness of the electrode composite layer and the average thickness of the insulating layer approximately equal. This sequence helps to distribute the pressure load, even if high pressure is applied during pressing the solid electrolyte layer provided on the electrode.

Regarding the pressing pressure, there are no particular restrictions, and it can be appropriately selected according to the objective; however, it is preferable to apply a pressure that enables the substrate and the electrode composite layer to be bonded and densification of the electrode composite layer at the same time. More specifically, a pressure between 1 MPa and 900 MPa is preferable, and a range between 50 MPa and 300 MPa is even more preferable.

Regarding the pressing device, there are no particular restrictions; it can be performed using commercially available pressure molding equipment. The electrode composite layer and the structured layer are possibly pressed in the electrode substrate direction. Examples include, but are not limited to, uniaxial presses, roll presses, cold isostatic presses (CIP), and hot presses. Among these, cold isostatic presses (CIP), which can apply isotropic pressure, are preferred.

### Method of Manufacturing Electrochemical Element and Apparatus for Manufacturing Electrochemical Element

The method of manufacturing an electrochemical element according to the present disclosure includes a process of manufacturing a member for an electrochemical element that manufacture the member for an electrochemical element by the method of manufacturing the member for an electrochemical element, a process of manufacturing the electrochemical element that manufactured the electrochemical element using the member for the electrochemical element, and other optional processes such as pressing process.

In other words, the method of manufacturing an electrochemical element according to the present disclosure includes a process of forming an electrode laminate that manufactures the electrode laminate by the method of manufacturing the electrode laminate, a process of manufacturing the electrochemical element using the electrode laminate, and other optional processes.

The apparatus for manufacturing an electrochemical element according to the present disclosure includes a device for manufacturing a member for an electrochemical element that manufactures the member for an electrochemical element, a device for manufacturing the electrochemical element using the electrochemical element member, and may furthermore optionally include other optionally devices such as a device for forming a solid electrolyte layer and a pressing device.

In other words, the device for manufacturing an electrochemical element according to the present disclosure includes a device for manufacturing an electrode laminate that manufactures the electrode laminate by the device for manufacturing the electrode laminate, a device for manufacturing the element that manufactures the electrochemical element using the electrode laminate.

The method of manufacturing an electrochemical element can be suitably carried out using the apparatus for manufacturing an electrochemical element.

### Method of Manufacturing Member for Electrochemical Element and Apparatus for Manufacturing Member for Electrochemical Element

The process of manufacturing a member for an electrochemical element can use the same processes as those described in Method for Manufacturing Member for Electrochemical Element and Apparatus for Manufacturing Member for Electrochemical Element, and therefore, redundant descriptions are omitted. Similarly, the process of manufacturing an electrode laminate can use the same processes as those described in Method of Manufacturing Electrode Laminate and Apparatus for Manufacturing Electrode Laminate, and therefore, redundant descriptions are omitted.

The device for manufacturing a member for an electrochemical element can use the same device as those described in Method of Manufacturing Member for Electrochemical Element and Apparatus for Manufacturing Member for electrochemical Element, and therefore, redundant descriptions are omitted. Similarly, the apparatus for manufacturing the electrode laminate can use the same apparatus as those described Method of Manufacturing Electrode Laminate and Apparatus for Manufacturing Electrode Laminate, and therefore, redundant descriptions are omitted.

### Element Forming Process and Element Forming Apparatus

The element forming process is for manufacturing an electrochemical element using an electrode laminate.

The element forming apparatus is for manufacturing an electrochemical element using an electrode or electrode laminate.

There are no particular restrictions on the method of manufacturing an electrode or electrochemical element using an electrode laminate, and an appropriate, known method of manufacturing an electrochemical element may be selected according to a particular application. For example, it may include at least one of placing counter electrodes, winding or laminating, and housing in a container.

Note that the element forming process does not need to include all processes of element forming and may include only a part of the processes involved in element forming.

### Electrode Processing Process and Electrode Processing Device

The other process may include an electrode processing process.

The other device may include an electrode processing device.

The electrode processing device is for processing the electrode or electrode laminate with an insulating layer. The electrode processing device may perform at least one of cutting, folding, and laminating. The electrode processing device is for processing the electrode or electrode laminate with a structured layer. The electrode processing device may, for example, wind or laminate the electrode or electrode laminate with a structured layer.

The electrode processing device may, for example, include an electrode processing device that performs cutting, accordion folding, laminating, or winding of the electrode or electrode laminate with a structured layer according to the desired battery format.

The electrode processing process performed by the electrode processing device is, for example, a process of processing an electrode or an electrode laminate in which a structured layer is formed. The electrode processing process may include at least one of a cutting process, folding process, and laminating process.

An embodiment of the electrochemical element relating to the present disclosure is described with reference to the drawings. The present disclosure is not limited to these embodiments.

FIG. 13

FIG. 13 is a schematic view illustrating the electrochemical element according to one embodiment of the present disclosure.

The all solid state battery illustrated in FIG. 13 has a positive electrode and a negative electrode laminated with a solid electrolyte 30 in between.

An insulating layer 15 and a positive electrode composite layer 20 are provided on both surfaces of the positive electrode substrate 21.

A negative electrode mixture layer 40 formed on both sides of a negative electrode substrate 44.

A lead wire 50 is connected to the positive electrode substrate 21, and a lead wire 51 is connected to the negative electrode substrate 44.

The number of stacked layers is not particularly limited. The number of the positive electrode and the negative electrode can be the same or different.

The lead wires 50 and 51 are drawn out to the outside of the outer casing 60.

### Usage of Electrochemical Element

The application of the electrochemical device is not particularly limited.

Examples include, but are not limited to: mobile objects such as vehicles; and electric devices, such as mobile phones, notebook computers, pen-input personal computers, mobile personal computers, electronic book players, cellular phones, portable facsimiles, portable copiers, portable printers, headphone stereos, video movies, liquid crystal televisions, handy cleaners, portable compact discs (CDs), minidiscs, transceivers, electronic notebooks, calculators, memory cards, portable tape recorders, radios, backup power supplies, motors, lighting devices, toys, game machines, watches, strobes, and cameras. Of these, vehicles and electric devices are particularly preferable.

The mobile objects include, but are not limited to, ordinary vehicles, heavy special cars, small special vehicles, trucks, heavy motorcycles, and ordinary motorcycles.

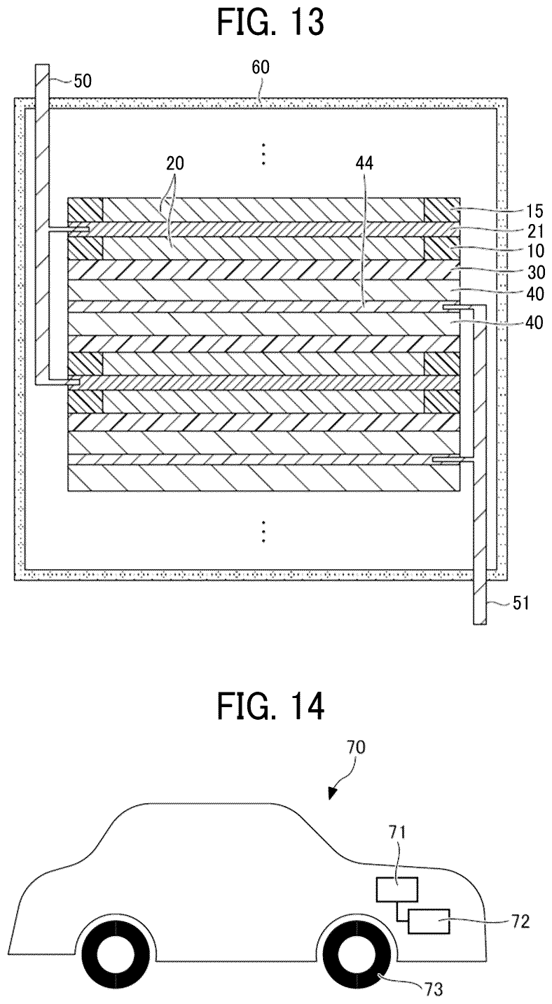

FIG. 14; Mobile Object

FIG. 14 is a schematic diagram illustrating a mobile object, which is an electrochemical element according to an embodiment of the present disclosure.

A mobile object 70 is an electric vehicle, for example. The mobile object 70 includes a motor 71, an electrochemical device 72, and wheels 73 as an example of transportation device. The electrochemical device 72 is the electrochemical device of the present disclosure. The electrochemical device 72 drives a motor 71 by supplying electricity to the motor 71. The motor 71 driven can drive the wheels 73, and as a result, the mobile object 70 can move.

According to the configuration described above, it prevents short circuits between the positive and negative electrodes, and is driven by the power from an electrochemical device that has excellent battery properties, allowing the vehicle to move safely and efficiently.

The mobile object 70 can be applied not only to an electric vehicle but to a plug-in hybrid vehicle, a hybrid electric vehicle, and a locomotive or motorcycle that can travel on the combination of a diesel engine and an electrochemical device. In addition, the mobile object can be a transport robot used in a factory, which can travel on an electrochemical device alone or a combination of an electrochemical device and an engine. The mobile object includes a partially-movable object like an assembly robot in a factory's production line which has an arm performing on an electrochemical device or a combination of an engine and an electrochemical device.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples and Comparative Examples but is not limited thereto. In the following Examples and Comparative Examples, “parts” represents “parts by mass” and, “percent”, “percent by mass”, unless otherwise specified.

### Preparation of Liquid Composition 1

A liquid composition 1 was obtained by mixing 49.5 percent by mass of tetrahydrolinalool (available from Tokyo Chemical Industry Co., Ltd., boiling point: 196 degrees Celsius) as a solvent, 50.0 percent by mass of polyethylene glycol (200) diacrylate (available from Daicel-Olnex Co., Ltd.) as a polymerizable compound, and 0.5 percent by mass of bis(2,4,6-trimethylbenzoyl)phenylphosphinate (available from IGM Resins B.V.) as a polymerization initiator.

### Preparation of Liquid Composition 2

A liquid composition 2 was obtained by mixing 49.5 percent by mass of undecane (available from Kanto Chemical Industry Co., Ltd., boiling point: 196 degrees Celsius) as a solvent, 50.0 percent by mass of polyethylene glycol (200) diacrylate (available from Daicel-Olnex Co., Ltd.) as a polymerizable compound, and 0.5 percent by mass of bis(2,4,6-trimethylbenzoyl)phenylphosphinate as a polymerization initiator.

### Preparation of Liquid Composition 3

A liquid composition 3 was obtained by mixing 49.5 percent by mass of decane (available from Kanto Chemical Industry Co., Ltd., boiling point: 174 degrees Celsius) as a solvent, 50.0 percent by mass of polyethylene glycol (200) diacrylate (available from Daicel-Olnex Co., Ltd.) as a polymerizable compound, and 0.5 percent by mass of bis(2,4,6-trimethylbenzoyl)phenylphosphinate as a polymerization initiator.

### Example 1

### Manufacturing of Member for Electrochemical Element

The first liquid composition, Liquid Composition 1, was filled into an inkjet discharging device equipped with an inkjet head (MH5421F, available from Ricoh Industry Co., Ltd.). An aluminum foil substrate (50 mm×50 mm, average thickness: 15 μm) was placed on a stage, and the liquid was discharged to form a structure with an outer shape of 40 mm×40 mm, a structured layer width of 10 mm, and an opening of 20 mm×20 mm where the substrate was exposed. The coated area was then immediately exposed to UV light under a nitrogen atmosphere (light source: UV-LED, product name: FJ800, available from Phoscon Technology, wavelength: 365 nm, irradiation intensity: 30 mW/cm², irradiation time: 20 s) to cure the coating.

Subsequently, as the second liquid composition, Liquid Composition 1 was applied to the other surface of the substrate using an inkjet discharging device equipped with a GEN5 head (available from Ricoh Printing Systems Co., Ltd.). The coated area was set to have the same shape as the surface where the first liquid composition was applied. The coated area was then immediately exposed to UV light under a nitrogen atmosphere (light source: UV-LED, product name: FJ800, available from Phoscon Technology, wavelength: 365 nm, irradiation intensity: 30 mW/cm², irradiation time: 20 s) to cure the coating.

Next, using a hot-air dryer, both sides of the substrate were heated at 120 degrees Celsius for 1 minute to remove the solvent, thereby producing Member 1 for Electrochemical Element. The Member 1 for Electrochemical Element had structured layers 1 and 2 with an outer size of 41 mm×41 mm.

The structured layer obtained from the first liquid composition is referred to as Structured Layer 1, and the structured layer obtained from the second liquid composition is referred to as Structured Layer 2.

### Measurement of Average Thickness

The average thickness of Structured Layers 1 and 2 in the Member 1 for Electrochemical Element was measured using a laser microscope (VKX-3000, available from KEYENCE CORPORATION), and both were found to be 95 μm. Therefore, the film thickness ratio between Structured Layer 1 and Structured Layer 2 is 1.

### Measurement of Overlap Ratio

For Member 1 for Electrochemical Element, images of both Surface A and Surface B, where each structured layer was formed, were captured using an optical microscope (VHX-7000, available form KEYENCE CORPORATION) to create image data. The imaging conditions were set to a lens magnification of 20× and divided imaging (2D stitching). The area of Region A on the Surface A and the area of Region B on the surface B were calculated using the area measurement function of the luminance extraction area installed on the VHX-7000. Next, a merged image was created from the image data of Surface A and Surface B using ImageJ, an image processing software, and the overlapping area between Region A and Region B was calculated. The overlap ratios A and B were calculated using the following relationship:

$$Overlap ratio A = ( overlap area / area of region A ) \times 10$$

$$Overlap ratio B = ( Overlap area / Area of region B ) \times 100$$

### Evaluation on Curling

The Member 1 for Electrochemical Element obtained was placed on a horizontal surface, and the maximum height (mm) of the substrate's lifted edge was measured as “warpage.” The evaluation was conducted based on the following criteria:

### Evaluation Criteria

S: Warpage is 0 mm to less than 1 mm
A: Warpage is 1 mm to less than 3 mm
B: Warpage is 3 mm to less than 5 mm
C: Warpage is at least 5 mm

### Examples 2 to 10

The Members for Electrochemical Elements of Examples 2 to 10 were prepared in the same manner as in Example 1 except that the conditions were changes to those shown in Table 1 and were then subjected to each measurement and evaluation. The results are shown in Table 1.

In Examples 3, 8, and 10, Structured Layer 2 was formed without an opening.

In Example 6, a hot plate (CHP-250DF, available from AS ONE Corporation) was used as the device for forming a structured layer, and both sides of the substrate were heated at 120 degrees Celsius for 1 minute.

In Example 7, an electron beam was irradiated to form the precursor of the structured layer.

### Comparative Example 1

The Member 1 for Comparative Electrochemical Element was prepared for each measurement and evaluation in the same manner as in Example 1 except that the overlap ratio was changed to 75 percent. The results are shown in Table 1.

### Comparative Example 2

The first liquid composition, Liquid Composition 1, was filled into an inkjet discharging device equipped with an inkjet head (MH5421F, available from Ricoh Industry Co., Ltd.). An aluminum foil substrate (50 mm×50 mm, average thickness: 15 μm) was placed on a stage, and the liquid was discharged to form a structure with an outer shape of 40 mm×40 mm, a structured layer width of 10 mm, and an opening of 20 mm×20 mm where the substrate was exposed. The coated area was then immediately exposed to UV light under a nitrogen atmosphere (light source: UV-LED, product name: FJ800, available from Phoseon Technology, wavelength: 365 nm, irradiation intensity: 30 mW/cm², irradiation time: 20 s) to cure the coating.

Next, using a hot-air dryer, the substrate was heated at 120 degrees Celsius for one minute to remove the solvent.

Subsequently, as the second liquid composition, Liquid Composition 1 was applied to the other surface of the substrate using an inkjet discharging device equipped with a GEN5 head (available from Ricoh Printing Systems Co., Ltd.). The coated area was set to have the same shape as the surface where the first liquid composition was applied. The coated area was then immediately exposed to UV light under a nitrogen atmosphere (light source: UV-LED, product name: FJ800, available from Phoseon Technology, wavelength: 365 nm, irradiation intensity: 30 mW/cm², irradiation time: 20 s) to cure the coating.

Next, using a hot-air dryer, the other surface of the substrate was heated at 120 degrees Celsius for 1 minute to remove the solvent, thereby producing Member 2 for Comparative Electrochemical Element.

Each measurement and evaluation were then performed. The results are shown in Table 1.

TABLE 1

| | | | Structured layer | | | | | |
|---|---|---|---|---|---|---|---|---|
| | Substrate | | Structured layer 1 | | | Structured layer 2 | | |
| | | Average | | | Average | | | Average |
| | | thickness | Liquid | | thickness | Liquid | | thickness |
| | Type | (μm) | composition | Opening | (μm) | composition | Opening | (μm) |
| Example 1 | Aluminum | 15 | Liquid | Yes | 95 | Liquid | Yes | 95 |
| | | | composition 1 | | | composition 1 | | |
| Example 2 | SUS304 | 50 | Liquid | Yes | 140 | Liquid | Yes | 70 |
| | | | composition 1 | | | composition 2 | | |
| Example 3 | Aluminum | 15 | Liquid | Yes | 100 | Liquid | None | 120 |
| | | | composition 1 | | | composition 1 | | |
| Example 4 | Aluminum | 15 | Liquid | Yes | 125 | Liquid | Yes | 50 |
| | | | composition 1 | | | composition 1 | | |
| Example 5 | Aluminum | 15 | Liquid | Yes | 100 | Liquid | Yes | 110 |
| | | | composition 1 | | | composition 3 | | |
| Example 6 | Aluminum | 15 | Liquid | Yes | 120 | Liquid | Yes | 100 |
| | | | composition 1 | | | composition 1 | | |
| Example 7 | Aluminum | 15 | Liquid | Yes | 75 | Liquid | Yes | 135 |
| | | | composition 1 | | | composition 1 | | |
| Example 8 | Aluminum | 15 | Liqui | Yes | 147 | Liquid | None | 70 |
| | | | composition 1 | | | composition 1 | | |
| Example 9 | Aluminum | 15 | Liquid | Yes | 60 | Liquid | Yes | 138 |
| | | | composition 1 | | | composition 3 | | |
| Example 10 | Aluminum | 15 | Liquid | Yes | 130 | Liquid | None | 100 |
| | | | composition 1 | | | composition 3 | | |
| Comparative | Aluminum | 15 | Liquid | Yes | 95 | Liquid | Yes | 95 |
| Example 1 | | | composition 1 | | | composition 1 | | |
| Comparative | Aluminum | 15 | Liquid | Yes | 95 | Liquid | Yes | 95 |
| Example 2 | | | composition 1 | | | composition 1 | | |

| | | | | Device for | | |
|---|---|---|---|---|---|---|
| | Structured layer | | | forming | | |
| | Layer | Overlapping | Overlapping | structured | Polymerizing | Evaluation on |
| | thickness ratio | ratio A | ratio B | layer | device | warpage |
| Example 1 | 1 | 98 percent | 98 percent | Hot air | Light | S |
| | | | | dryer | irradiation | |
| Example 2 | 2 | 80 percent | 80 percent | Hot air | Light | S |
| | | | | dryer | irradiation | |
| Example 3 | 1.2 | 85 percent | 60 percent | Hot air | Light | A |
| | | | | dryer | irradiation | |
| Example 4 | 2.5 | 90 percent | 90 percent | Hot air | Light | A |
| | | | | dryer | irradiation | |
| Example 5 | 1.1 | 95 percent | 95 percent | Hot air | Light | A |
| | | | | dryer | irradiation | |
| Example 6 | 1.2 | 90 percent | 90 percent | Hot plate | Light | A |
| | | | | | irradiation | |
| Example 7 | 1.8 | 95 percent | 95 percent | Hot air | Light beam | A |
| | | | | dryer | irradiation | |
| Example 8 | 2.1 | 85 percent | 60 percent | Hot air | Light | B |
| | | | | dryer | irradiation | |
| Example 9 | 2.3 | 90 percent | 90 percent | Hot air | Light | B |
| | | | | dryer | irradiation | |
| Example 10 | 1.3 | 95 percent | 70 percent | Hot air | Light | B |
| | | | | dryer | irradiation | |
| Comparative | 1 | 75 percent | 75 percent | Hot air | Light | C |
| Example 1 | | | | dryer | irradiation | |
| Comparative | 1 | 98 percent | 98 percent | Hot air | Light | C |
| Example 2 | | | | dryer | irradiation | |

| | Device for forming | Polymerizing | Evaluation |
|---|---|---|---|
| | structured layer | device | on warpage |
| Example 1 | Hot air | Light | S |
| | dryer | irradiation | |
| Example 2 | Hot air | Light | S |
| | dryer | irradiation | |
| Example 3 | Hot air | Light | A |
| | dryer | irradiation | |
| Example 4 | Hot air | Light | A |
| | dryer | irradiation | |
| Example 5 | Hot air | Light | A |
| | dryer | irradiation | |
| Example 6 | Hot plate | Light | A |
| | | irradiation | |
| Example 7 | Hot air | Light beam | A |
| | dryer | irradiation | |
| Example 8 | Hot air | Light | B |
| | dryer | irradiation | |
| Example 9 | Hot air | Light | B |
| | dryer | irradiation | |
| Example 10 | Hot air | Light | B |
| | dryer | irradiation | |
| Comparative | Hot air | Light | C |
| Example 1 | dryer | irradiation | |
| Comparative | Hot air | Light | C |
| Example 2 | dryer | irradiation | |

As seen in the results of Examples 1 and 2, it is obvious that if the present disclosure is implemented in a preferred embodiment as described in the present specification, a superior curl suppression effect can be achieved.

As seen in the results of Examples 3, 8, and 10, it can be seen that if the shapes of the structured layer 1 and the structured layer 2 are identical, the curl suppression effect is excellent.

As seen in the results of Examples 4, 8, and 9, it is obvious that if the ratio of the average thickness of structured layer 1 to the average thickness of structured layer 2 is at most 2, the curl suppression effect is excellent.

As seen in the results of Examples 5, 9, and 10, it can be seen that if the boiling point difference between the first solvent and the second solvent is at most 10 degrees C., the curl suppression effect is excellent.

As seen in the results of Example 6, it is obvious that if the device for forming a structured layer removes the solvent by applying hot air to both sides of the substrate, the curl suppression effect is excellent.

As seen in the results of Example 7, it can be seen that if polymerization of the first liquid composition and the second liquid composition is carried out by light irradiation, the curl suppression effect is excellent.

In Comparative Example 1, since the overlap ratio was less than 80 percent, the curl suppression effect was reduced, resulting in formation of a curled member for an electrochemical element.

In Comparative Example 2, since the process of forming a structured layer was performed after the process of polymerizing the first and second liquid composition, the curl suppression effect was lost, resulting in formation of a curled electrochemical element.

Aspects of the present disclosure include, but are not limited to the following:

### Aspect 1

A method of manufacturing a member for an electrochemical includes applying a first liquid composition containing a first polymerizable compound and a first solvent to one side of a substrate, polymerizing the first polymerizable compound in the first liquid composition applied to the one side of the substrate, applying a second liquid composition containing a second polymerizable compound and a second solvent to a rest side of the substrate, polymerizing the second polymerizable compound in the second liquid composition applied to the rest side of the substrate, and removing the first solvent in the first liquid composition after the polymerizing the first polymerizable compound to form a first structured layer and removing the second solvent in the second liquid composition after the polymerizing the second polymerizable compound to form a second structured layer, to form a structured layer, wherein at least one of region A, to which the first liquid composition is applied, and region B, to which the second liquid composition is applied, overlaps each other by at least 80 percent in a plan view of the substrate.

### Aspect 2

The method according to Aspect 1 mentioned above, wherein the first liquid composition and the second liquid composition are applied in the same pattern to both sides of the substrate.

### Aspect 3

The method according to Aspect 2 mentioned above, wherein the first liquid composition and the second liquid composition are applied to the same portion of both sides of the substrate.

### Aspect 4

The method according to any one of Aspects 1 to 3 mentioned above, wherein the following Relationships 1 and 2 are satisfied,

$$\vert C - D \vert \leq C \qquad Relationship 1$$

$$\vert C - D \vert \leq D \qquad Relationship 2$$

where C represents the average thickness (μm) of the first structured layer formed from the first liquid composition and D represents the average thickness (μm) of the second structured layer formed from the second liquid composition.

### Aspect 5

The method according to any one of Aspects 1 to 4 mentioned above, wherein both the first liquid composition and the second liquid composition have the same composition.

### Aspect 6

The method according to any one of Aspects 1 to 5 mentioned above, wherein the difference between the boiling point of the first solvent and the boiling point of the second solvent is at most 10 degrees Celsius.

### Aspect 7

The method according to any one of Aspects 1 to 5 mentioned above, wherein both the first structured layer formed from the first liquid composition and the second structured layer formed from the second liquid composition have a frame shape.

### Aspect 8

The method according to any one of Aspects 1 to 7 mentioned above, wherein at least one of the first structured layer formed from the first liquid composition or the second structured layer formed from the second liquid composition has a porous structure.

### Aspect 9

The method according to Aspect 8 mentioned above, wherein the porous structure has a co-continuous structure with a resin framework.

### Aspect 10

The method according to any one of Aspects 1 to 9 mentioned above, wherein both the polymerizing the first liquid composition and the polymerizing the second liquid composition are carried out by light irradiation.

### Aspect 11

The method according to any one of Aspects 1 to 10 mentioned above, wherein the substrate has an average thickness of at most 50 μm.

### Aspect 12

The method according to any one of Aspects 1 to 11 mentioned above, wherein both the first solvent and the second solvent each respectively have a viscosity of 1 mPa's to 150 mPa·s at 25 degrees Celsius.

### Aspect 13

The method according to any one of Aspects 1 to 12 mentioned above, wherein both the first liquid composition and the second liquid composition each respectively contain polymerizable compounds each having two or more radical polymerizable functional groups per molecule and non-aqueous solvents.

### Aspect 14

The method according to any one of Aspects 1 to 13 mentioned above, wherein the removing the first solvent and removing the second solvent are carried out simultaneously.

### Aspect 15

The method according to any one of Aspects 1 to 14 mentioned above, wherein both the applying the first liquid composition and the applying the second liquid composition are carried out by inkjetting.

### Aspect 16

An apparatus for manufacturing an electrochemical element comprising:
a device for manufacturing a member for the electrochemical element by the method of any one of Aspects 1 to 15 mentioned above and a device for manufacturing the electrochemical element using the member.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A method of manufacturing a member for an electrochemical comprising:
applying a first liquid composition containing a first polymerizable compound and a first solvent to one side of a substrate;
polymerizing the first polymerizable compound in the first liquid composition applied to the one side of the substrate;
applying a second liquid composition containing a second polymerizable compound and a second solvent to a rest side of the substrate;
polymerizing the second polymerizable compound in the second liquid composition applied to the rest side of the substrate; and
removing the first solvent in the first liquid composition after the polymerizing the first polymerizable compound to form a first structured layer and removing the second solvent in the second liquid composition after the polymerizing the second polymerizable compound to form a second structured layer,
wherein at least one of region A, to which the first liquid composition is applied, and region B, to which the second liquid composition is applied, overlaps each other by at least 80 percent in a plan view of the substrate.

2. The method according to claim 1,
wherein the first liquid composition and the second liquid composition are applied in the same pattern to both sides of the substrate.

3. The method according to claim 2,
wherein the first liquid composition and the second liquid composition are applied to the same portion of both sides of the substrate.

4. The method according to claim 1,
wherein the following Relationships 1 and 2 are satisfied,
$$\vert C - D \vert \leq C \qquad Relationship 1$$
$$\vert C - D \vert \leq D \qquad Relationship 2$$
where C represents an average thickness (μm) of the first structured layer formed from the first liquid composition and D represents an average thickness (μm) of the second structured layer formed from the second liquid composition.

5. The method according to claim 1,
wherein both the first liquid composition and the second liquid composition have the same composition.

6. The method according to claim 1,
wherein a difference between a boiling point of the first solvent and a boiling point of the second solvent is at most 10 degrees Celsius.

7. The method according to claim 1,
wherein both the first structured layer formed from the first liquid composition and the second structured layer formed from the second liquid composition have a frame shape.

8. The method according to claim 1,
wherein at least one of the first structured layer formed from the first liquid composition or the second structured layer formed from the second liquid composition has a porous structure.

9. The method according to claim 8,
wherein the porous structure has a co-continuous structure with a resin framework.

10. The method according to claim 1,
wherein both the polymerizing the first liquid composition and the polymerizing the second liquid composition are carried out by light irradiation.

11. The method according to claim 1,
wherein the substrate has an average thickness of at most 50 μm.

12. The method according to claim 1,
wherein both the first solvent and the second solvent each respectively have a viscosity of 1 mPa's to 150 mPa's at 25 degrees Celsius.

13. The method according to claim 1,
wherein both the first liquid composition and the second liquid composition each respectively contain polymerizable compounds each having two or more radical polymerizable functional groups per molecule and non-aqueous solvents.

14. The method according to claim 1,
wherein the removing the first solvent and removing the second solvent are carried out simultaneously.

15. The method according to claim 1,
wherein both the applying the first liquid composition and the applying the second liquid composition are carried out by inkjetting.

16. An apparatus for manufacturing an electrochemical element comprising:
a device for manufacturing a member for the electrochemical element by the method of claim 1; and
a device for manufacturing the electrochemical element using the member.
